(19) United States
(12) Patent Application Publication
(10) Pub. No.: US 2008/0146427 A1
(43) Pub. Date: Jun. 19, 2008

(54) ELECTRICAL CONDUCTIVE ROLLER AND IMAGING APPARATUS COMPRISING THE SAME

(75) Inventor: Akihide Osaku, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Tokyo (JP)

(21) Appl. No.: 11/938,904

(22) Filed: Nov. 13, 2007

(30) Foreign Application Priority Data
Nov. 16, 2006 (JP) 2006-310121
Dec. 7, 2006 (JP) 2006-330807

(51) Int. Cl. F16C 13/00

(52) U.S. Cl. 492/56

(57) ABSTRACT

An electrical conductive roller comprises a shaft member, an elastic layer disposed on an outer side of the shaft member in a radial direction and at least one resin coating layer disposed on an outer side of the elastic layer in the radial direction, wherein a resin coating layer at least adjacent to the elastic layer is made of a ultraviolet-cured resin formed by curing a paint for the resin coating layer comprising (A) a (metha)acrylate oligomer, (B) a (metha)acrylate monomer and (C) a photopolymerization initiator through irradiation of ultraviolet rays, and having an elongation at break of not less than 80%.

### BACKGROUND OF THE INVENTION

1. Field of the Invention

This invention relates to an electrical conductive roller comprising an elastic layer and a resin coating layer and an imaging apparatus comprising such an electrical conductive roller, and more particularly to an electrical conductive roller having an improved durability and an imaging apparatus comprising such an electrical conductive roller and capable of forming good images.

2. Description of the Related Art

In general, a roll-shaped electrically conductive elastic member, i.e. an electrical conductive roller is frequently used as a developing roller, a charge roller, a toner feed roller, a transfer roller, a paper feed roller, a cleaning roller, a pressing fuser roller or the like in an imaging apparatus of an electrophotographic system such as a copier, a facsimile, a laser beam printer (LBP) or the like. The electrical conductive roller usually comprises a shaft member attached so as to bear both end portions in a longitudinal direction thereof and one or more elastic layers disposed outside the shaft member in a radial direction. Further, a resin coating layer may be provided on the surface of the elastic layer in the electrical conductive roller for the purpose of increasing the hardness of the roller, controlling the charging property and adhesiveness to toners, preventing contamination of a photosensitive drum through the elastic layer and the like.

As the shaft member of the electrical conductive roller are used a metal such as iron, stainless steel or the like, and various resins such as engineering plastics and the like. As the elastic layer of the electrical conductive roller are used elastomers such as silicone rubber, acrylonitrile-butadiene rubber (NBR), ethylene-propylene-diene rubber (EPDM), epichlorohydrin rubber (ECO), polyurethane and the like. The elastic layer is produced by pouring a starting material for the elastomer into a mold having a desired cavity shape and curing under heating. Furthermore, the resin coating layer is formed by dipping a roller body comprising the shaft member and the elastic layer in a solvent-based or water-based coating solution containing a resin or spraying such a coating solution onto the roller body and then dry-curing with heat or hot air. At this moment, the drying for the formation of the resin coating layer is required to take a long time, and hence a long drying line is required in the mass production thereof. Also, the resin coating layer is required to have delicate electrical conductivity and surface state for its applications, but the scattering of temperature distribution, air volume and the like in the drying line largely exerts on the performances of the resin coating layer, so that there is a problem in the quality thereof.

On the other hand, as a method of forming the resin coating layer having a stable quality without requiring the long drying line, there is proposed a technique wherein a ultraviolet curing resin paint is applied onto a surface of an elastic layer in a roller and the resin paint is cured to form a resin coating layer made of the ultraviolet cured resin on the surface of the elastic layer (see JP-A-2002-310136).

However, the resin coating layer formed by curing the ultraviolet curing resin paint through ultraviolet rays is usually high in the hardness and has not a sufficient stretching property. For this end, when the electrical conductive roller provided with such a resin coating layer is used in an imaging apparatus, the resin coating layer is chipped off in the use and hence the poor imaging is easily be caused. Particularly, when the elastic layer of the electrical conductive roller is made of a foamed body (foam), the chipping of the resin coating layer is remarkably caused and there is a problem in the durability.

### SUMMARY OF THE INVENTION

It is, therefore, an object of the invention to provide an electrical conductive roller comprising a resin coating layer of a stable quality and improving the durability without requiring a long drying line in the production step. Also, it is another object of the invention to provide an imaging apparatus using such an electrical conductive roller and capable of stably forming good images.

The inventor has made various studies in order to achieve the above objects, and found that in an electrical conductive roller provided on a surface of an elastic layer with a resin coating layer, a ultraviolet-cured resin formed by curing a paint composition comprising a (metha)acrylate oligomer, a (metha)acrylate monomer and a photopolymerization initiator through irradiation of ultraviolet rays is used in the resin coating layer to obtain an electrical conductive roller having good elongation property of the resin coating layer and an excellent durability, and as a result, the invention has been accomplished.

That is, the electrical conductive roller according to the invention comprises a shaft member, an elastic layer disposed on an outer side of the shaft member in a radial direction and at least one resin coating layer disposed on an outer side of the elastic layer in the radial direction, wherein a resin coating layer at least adjacent to the elastic layer is made of a ultraviolet-cured resin formed by curing a paint for the resin coating layer comprising (A) a (metha)acrylate oligomer, (B) a (metha)acrylate monomer and (C) a photopolymerization initiator through irradiation of ultraviolet rays, and having an elongation at break of not less than 80%.

In the electrical conductive roller according to the invention, the ultraviolet-cured resin is preferable to have an elastic modulus of not more than 280 MPa in addition to the elongation at break of not less than 80% for developing the excellent durability.

In a preferable embodiment of the electrical conductive roller according to the invention, the resin coating layer has a glass transition point of not lower than 40° C. and a friction coefficient of not more than 0.5. In this case, the printing durability of the electrical conductive roller is further improved.

In the electrical conductive roller according to the invention, the (metha)acrylate oligomer (A) is preferable to have a weight average molecular weight of not less than 4500.

In a preferable embodiment of the electrical conductive roller according to the invention, the (metha)acrylate oligomer (A) is a urethane-based (metha)acrylate oligomer.

In another preferable embodiment of the electrical conductive roller according to the invention, the (metha)acrylate monomer (B) is at least one selected from acryloylmorpholine, N,N-diethylaminoethyl methacrylate, isobornyl acrylate and phenoxyethyl acrylate.

In the electrical conductive roller according to the invention, it is preferable that a content of the (metha)acrylate monomer (B) in a sum of the (metha)acrylate oligomer (A) and the (metha)acrylate monomer (B) is 10-60% by mass.

In a preferable embodiment of the electrical conductive roller according to the invention, the resin coating layer contains finer particles. In this case, the surface modifying effect of the electrical conductive roller is obtained, the printing durability can be improved sufficiently.

In another preferable embodiment of the electrical conductive roller according to the invention, the resin coating layer contains at least one selected from fluorine-containing resin and compound and silicon-containing resin and compound. In this case, the friction force of the resin coating layer can be reduced to sufficiently improve the printing durability of the electrical conductive roller. At his moment, the fluorine-containing resin and compound and the silicon-containing resin and compound may be a ultraviolet curing type or a non-ultraviolet curing type.

The electrical conductive roller according to the invention is particularly suitable as a developing roller.

Also, the imaging apparatus according to the invention comprises the above-mentioned electrical conductive roller.

According to the invention, in the electrical conductive roller provided on the surface of the elastic layer with the resin coating layer, there can be provided an electrical conductive roller improving the durability to the chipping of the resin coating layer by using as the resin coating layer the ultraviolet-cured resin, which is formed by curing the paint mixture of (metha)acrylate oligomer (A), (metha)acrylate monomer (B) and photopolymerization initiator (C) through irradiation of ultraviolet rays and has an elongation at break of not less than 80%. Moreover, the (metha)acrylate monomer (B) is preferable to be a (metha) acrylate monomer having one functional group number and a bulky substituent or polar group. Further, the elastic modulus of the ultraviolet-cured resin used in the resin coating layer is made to 280 MPa, whereby the durability is further improved. Thus, there can be provided an imaging apparatus comprising such an electrical conductive roller and capable of stably forming good images.

### BRIEF DESCRIPTION OF THE DRAWINGS

FIG. 1 is a diagrammatically section view of an embodiment of the electrical conductive roller according to the invention.

FIG. 2 is a partial section view of an embodiment of the imaging apparatus according to the invention.

### DESCRIPTION OF THE PREFERRED EMBODIMENTS

<Electrical Conductive Roller>

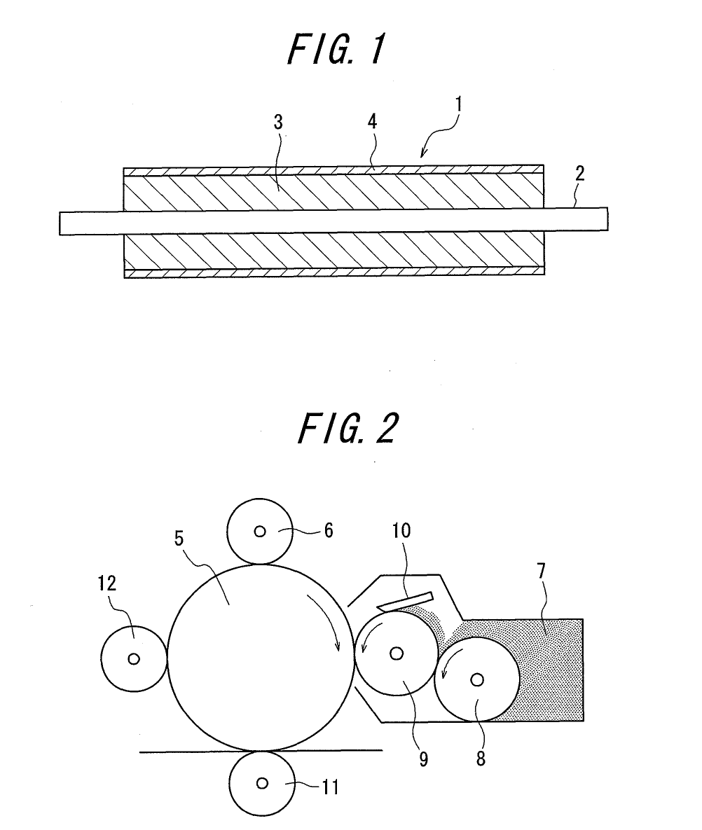

Next, the electrical conductive roller according to the invention will be described in detail with reference to the accompanying drawings. FIG. 1 is a diagrammatically section view of an embodiment of the electrical conductive roller according to the invention. The illustrated electrical conductive roller 1 comprises a shaft member 2, an elastic layer 3 disposed on an outer side of the shaft member 2 in a radial direction, and a resin coating layer 4 disposed on an outer side of the elastic layer 3 in the radial direction. Moreover, the electrical conductive layer 1 shown in FIG. 1 has only one resin coating layer 4, but the electrical conductive roller according to the invention may comprise two or more resin coating layers.

The electrical conductive roller according to the invention is characterized in that a resin coating layer 4 at least adjacent to the elastic layer 3 is made of a ultraviolet-cured resin formed by curing a paint for the resin coating layer comprising (A) a (metha)acrylate oligomer, (B) a (metha)acrylate monomer and (C) a photopolymerization initiator through irradiation of ultraviolet rays, and having an elongation at break of not less than 80%. At this moment, when the (metha)acrylate monomer (B) has one functional group number and a bulky substituent or polar group, the viscosity of the paint for the resin coating layer can be reduced but also proper toughness and elongation property can be given to the ultraviolet-cured resin. Also, in the electrical conductive roller according to the invention, there can be solved problems on the durability of the roller due to the chipping of the resin coating layer or the like because the elongation at break of the ultraviolet-cured resin is not less than 80%. Moreover, even when a layer other than the resin coating layer adjacent to the elastic layer has an elongation at break of not less than 80%, the desired effects are developed.

In the electrical conductive roller according to the invention, the durability can be further improved by rendering the elastic modulus of the resin coating layer 4 adjacent to the elastic layer 3 into not more than 280 MPa in addition to the elongation at break of not less than 80%. The electrical conductive roller is directly contacted with a member such as a photosensitive body or the like in the printing and rotated while nipping properly. As a result, stress concentrates in the resin coating layer 4 as an outermost layer. This stress becomes higher as the elastic modulus of the resin coating layer 4 is high. Therefore, the concentration of the stress into the resin coating layer 4 can be prevented by rendering the elastic modulus into not more than 280 MPa. Thus, there can be further solved the problems on the durability of the roller due to the chipping of the resin coating layer 4 and the like. When the resin coating layer having a low elastic modulus is used as a surface layer, the effect is more developed.

Also, when the resin coating layer in the electrical conductive roller according to the invention has a glass transition point (Tg) of not lower than 40° C. and a friction coefficient of not more than 0.5, the properties of the resin coating layer are further improved.

In the imaging apparatus comprising such an electrical conductive roller, as the use of the roller is continued, the change of properties of the surface of the resin coating layer as an outermost layer of the electrical conductive roller or the toners is caused to deteriorate the charging property of the electrical conductive roller to toners or the toner transferring property thereof, and hence the printing durability is deteriorated. Now, the inventor has made the detail examination on the deterioration of the printing durability and found that the magnitude of the friction coefficient in the resin coating layer is a factor of causing the deterioration. From this knowledge, it is considered that it is required to optimize the friction coefficient of the resin coating layer in the electrical conductive roller. In the electrical conductive roller according to the invention, the printing durability can be further improved by making the friction coefficient of the resin coating layer lower than that of the resin coating layer in the conventional electrical conductive roller and rendering into not more than 0.5. When the friction coefficient of the resin coating layer exceeds 0.5, strong friction force acts to toners or a contact portion with the other adjoining member or the like, so that the printing durability of the electrical conductive roller is largely deteriorated. Therefore, the friction coefficient of the resin coating layer is preferable to be within a range of 0.25-0.5 from a point of the balance of the friction force acting to the toners or the contact portion with the other adjoining member or the like. At this moment, the friction coefficient of the resin coating layer is a three-point average value of static friction coefficient measured by a friction meter attached with a felt used for toner sealing after the electrical conductive roller is fixed horizontally. As the friction meter is used HEIDON TRIBOGEARMUSE TYPE: 941, made by Shinto Kagaku Co., Ltd. Also, the friction coefficient of the resin coating layer can be adjusted by properly selecting components included in the resin coating layer, composition thereof and the like in addition to the glass transition point of the resin coating layer as mentioned in detail later.

Further, it is preferable in the electrical conductive roller according to the invention that the glass transition point (Tg) of the resin coating layer is not lower than 40° C. in addition to the friction coefficient of not more than 0.5. As means for controlling the friction coefficient of the resin coating layer in the electrical conductive roller as mentioned above, it is effective to include a resin and/or a compound having a small surface energy by introducing fluorine, silicon or the like as a functional group or to raise the glass transition point (Tg) of the resin coating layer. Additionally, the properties of the resin coating layer largely change on the glass transition point (Tg). For example, when the temperature of the resin coating layer exceeds the glass transition point (Tg), the elastic modulus lowers violently. In the imaging apparatus using the electrical conductive roller according to the invention, therefore, it is necessary that the glass transition point (Tg) of the resin coating layer is higher than a temperature used in the printing, i.e. it is required to be not lower than 40° C. and is preferable to be within a range of 40-90° C. Moreover, the glass transition point (Tg) of the resin coating layer may be adjusted by properly selecting components included in the resin coating layer, composition thereof and the like. For example, as the molecular weight of the oligomer used in the formation of the resin coating layer is made low, the glass transition point (Tg) becomes higher.

The shaft member in the electrical conductive roller according to the invention is not particularly limited as far as it has a good electrical conductivity, and there may be used, for example, a core made of a solid body of a metal such as iron, stainless steel, aluminum or the like, a metal shaft of a hollow metal cylinder formed by boring the interior of the solid body, a plastic shaft having a good electrical conductivity, and so on.

The elastic layer in the electrical conductive roller according to the invention is made from an elastomer and may contain another component such as an electrically conducting agent or the like, if necessary. As the elastomer used in the elastic layer are mentioned polyurethane, silicone rubber, ethylene-propylene-diene rubber (EPDM), acrylonitrile-butadiene rubber (NBR), natural rubber (NR), styrene-butadiene rubber (SBR), butadiene rubber (BR), isoprene rubber (IR), polynorbornene rubber, butyl rubber (IIR), chloroprene rubber (CR), acryl rubber, epichlorohydrin rubber (ECO), ethylene-vinyl acetate copolymer (EVA) and a mixture thereof, and so on. Among them, polyurethane is preferable. In the elastic layer may be used the elastomer as a non-foamed body or as a foamed body.

As the electrically conducting agent usable in the electric layer are mentioned an electron conducting agent, an ion conducting agent and the like. As the electron conducting agent are mentioned a conductive carbon such as Ketjenblack, acetyleneblack or the like; carbon blacks for rubber such as SAF, ISAF, HAF, FEF, GPF, SRF, FT, MT and the like; carbon black for color subjected to an oxidation treatment or the like, thermally decomposed carbon, natural graphite, artificial graphite, a metal oxide such as antimony-doped tin oxide, ITO, tin oxide, titanium oxide, zinc oxide or the like; a metal such as nickel, copper, silver, germanium or the like; a conductive polymer such as polyaniline, polypyrrole, polyacetylene or the like; a conductive whisker such as carbon whisker, graphite whisker, titanium carbide whisker, conductive potassium titanate whisker, conductive barium titanate whisker, conductive titanium oxide whisker, conductive zinc oxide whisker or the like; and so on. The amount of the electron conducting agent compounded is preferably a range of 1-50 parts by mass, more preferably a range of 5-40 parts by mass per 100 parts by mass of the elastomer.

As the ion conducting agent are mentioned an ammonium salt of a perchlorate, a chlorate, a hydrochloride, a bromate, an iodate, a borofluorohydride, a sulfate, an ethylsulfate, a carboxylate, a sulfonate or the like such as tetraethyl ammonium, tetrabutyl ammonium, dodecyl trimethyl ammonium, hexadecyl trimethyl ammonium, benzyl trimethyl ammonium, modified aliphatic dimethylethyl ammonium or the like; and a perchlorate, a chlorate, a hydrochloride, a bromate, an iodate, a borofluorohydride, a sulfate, a trifluoromethyl sulfate, a sulfonate or the like of an alkali metal or alkaline earth metal such as lithium, sodium, potassium, calcium, magnesium or the like. The amount of the ion conducting agent compounded is preferably a range of 0.01-10 parts by mass, more preferably a range of 0.05-5 parts by mass per 100 parts by mass of the elastomer. The above-mentioned conducting agents may be used alone or in a combination of two or more, and may be a combination of electron conducting agent and ion conducting agent.

The elastic layer is preferable to have a resistance value of 10³-10¹⁰ scm, more preferably 10⁴-10⁸ Ωcm based on the compounding of the above electrically conducting agent. When the resistance value of the elastic layer is less than 10³ Ωcm, there may be caused a case that electric charge is leaked onto the photosensitive drum or the like or the electrical conductive roller itself is broken by a voltage, while when it exceeds 10¹⁰ Ωcm, fogging is easily caused.

The elastic layer may be added with a crosslinking agent such as an organic peroxide or the like, and a vulcanizing agent such as sulfur or the like, if necessary for rendering the elastomer into a rubbery substance, and may further contain a vulcanizing assistant, a vulcanization accelerator, an accelerator activator, a retarder and the like. Also, the elastic layer may be compounded with additives for rubber such as a filler, a peptizer, a blowing agent, a plasticizer, a softening agent, a tackifier, an anti-tack agent, an isolating agent, a release agent, a thickener, a coloring agent and so on.

The elastic layer in the electrical conductive roller according to the invention is preferable to be made of a urethane foam obtained by expanding a urethane starting material through mechanical stirring, i.e. a mechanical frothing expanded urethane. The urethane foam is produced by mechanically stirring the urethane starting material to incorporate bubbles thereinto without using an expanding agent. As the urethane starting material are mentioned polyol and polyisocyanate, or urethane prepolymer synthesized from polyol and polyisocyanate and a chain extender, and further a catalyst, a foam stabilizer, the aforementioned electrically conducting agent and the like may be added to the urethane starting material. Also, the bubbles in the urethane foam are mainly closed cells, and the expansion ratio and density thereof can be properly adjusted by a way of blowing air.

As the polyol usable in the expanding urethane starting material are mentioned polyester polyol, polyether polyol, polytetramethylene glycol, polybutadiene polyol, propylene oxide (PO)-modified polybutadiene polyol, polyisoprene polyol and the like. Moreover, the polyester polyol is obtained, for example, by reacting a polyhydric alcohol such as ethylene glycol, diethylene glycol, 1,4-butane diol, 1,6-hexane diol, propylene glycol, trimethylol ethane, trimethylol propane or the like with a polybasic carboxylic acid such as adipic acid, glutaric acid, succinic acid, sebacic acid, pimelic acid, suberic acid or the like, and the polyether polyol is obtained, for example, by adding an alkylene oxide such as ethylene oxide, propylene oxide or the like to a polyhydric alcohol such as ethylene glycol, propylene glycol, glycerin or the like.

As the polyisocyanate usable in the expanding urethane starting material can be used tolylene diisocyanate (TDI), diphenylmethane diisocyanate (MDI), crude diphenylmethane diisocyanate (crude MDI), isophorone diisocyanate (IPDI), hydrogenated diphenylmethane diisocyanate, hydrogenated tolylene diisocyanate, hexamethylene diisocyanate (HDI); an isocyanurate-modified substance, a carbodiimide-modified substance or a glycol-modified substance thereof, and so on. The amount of the polyisocyanate used is preferable to be properly selected so that a ratio (NCO/OH) of isocyanate group (NCO) in the polyisocyanate to hydroxy group (OH) in the polyol is within a range of 95-100-110/100.

The polyisocyanate may be reacted with the polyol by a one-shot process, or it may be previously reacted with the polyol to form a urethane prepolymer and then reacted with a chain extender or the like in the presence of a catalyst. Moreover, the NCO group content in the synthesized urethane prepolymer is preferably a range of 3-30 mass %, more preferably a range of 5-15 mass %, while the amounts of the polyisocyanate and the polyol used in the synthesis of the urethane prepolymer are preferable to be properly selected so that the NCO group content in the urethane prepolymer satisfies the above range. The chain extender is a compound connecting the urethane prepolymers to each other, and concretely includes ethylene glycol, propylene glycol, butane diol, pentane diol, hexane diol, octane diol, trimethylol propane, polyether polyol, polytetramethylene glycol, polybutadiene polyol, polyisoprene polyol and the like. The amount of the chain extender used is preferable to be properly selected so that a ratio (NCO/OH) of isocyanate group (NCO) in the urethane prepolymer to hydroxy group (OH) in the chain extender is within a range of 95/100-110/100.

The catalyst usable in the expanding urethane starting material is a catalyst for urethanation reaction and concretely includes an organotin compound such as dibutyltin dilaurate, dibutyltin diacetate, dibutyltin thiocarboxylate, dibutyltin dimaleate, dioctyltin thiocarboxylate, tin octenate or the like; an organolead compound such as lead octenate or the like; a monoamine such as triethylamine, dimethylcyclohexylamine or the like; a diamine such as tetramethylethylene diamine, tetramethylpropane diamine, tetramethylhexane diamine or the like; a triamine such as pentamethyldiethylene triamine, pentamethyldipropylene triamine, tetramethyl guanidine or the like; a cyclic amine such as triethylene diamine, dimethylpiperazine, methylethylpiperazine, methylmorpholine, dimethylaminoethyl morpholine, dimethylimidazole or the like; an alcohol amine such as dimethylamino ethanol, dimethylaminoethoxy ethanol, trimethylaminoethyl ethanol amine, methylhydroxyethyl piperazine, hydroxyethyl morpholine or the like; an ether amine such as bis(dimethylaminoethyl)ether, ethylene glycol bis(dimethyl)aminopropyl ether or the like; and so on. Among these catalyst, the organotin compound is preferable. These catalysts may be used alone or in a combination of two or more. The amount of the catalyst used is preferable to be a range of 0.001-2.0 parts by mass per 100 parts by mass of the polyol or urethane prepolymer.

As the foam stabilizer usable in the expanding urethane starting material may be mentioned a silicone-based foam stabilizer such as a polyether-modified silicone oil or the like; an ionic surfactant, a nonionic surfactant and so on. The amount of the foam stabilizer used is preferable to be a range of 0.5-5.0 parts by mass per 100 parts by mass of the polyol or urethane prepolymer.

A roller body having an elastic layer 3 located outside a shaft member 2 in a radial direction can be obtained by pouring the elastomer starting material, preferably urethane staring material expanded through mechanical stirring into a cylindrical mold previously provided with the shaft member 2 and reaction-curing it.

The electrical conductive roller according to the invention comprises at least one resin coating layer outside the elastic layer in the radial direction for the purpose of increasing the hardness of the roller, controlling the charging property to toners or the adhesiveness, reducing friction force to the photosensitive drum, a stratification blade or the like, or preventing the contamination of the photosensitive drum or the like through the elastic layer. In the resin coating layer, a layer at least adjacent to the elastic layer is made of a ultraviolet-cured resin formed by curing a paint for the resin coating layer comprising (A) a (metha)acrylate oligomer, (B) a (metha)acrylate monomer and (C) a photopolymerization initiator through irradiation of ultraviolet rays. In the electrical conductive roller according to the invention, it is required that the resin coating layer at least adjacent to the elastic layer is made of the ultraviolet-cured resin, but when the electrical conductive roller has two or more resin coating layers, a resin coating layer other than the resin coating layer adjacent to the elastic layer is not particularly limited.

The (metha)acrylate oligomer (A) used in the paint for the resin coating layer is an oligomer having one or more acryloyloxy group (CH₂═CHCOO—) or methacryloyloxy group (CH₂═C(CH₃)COO—). The number of functional groups in the (metha)acrylate oligomer (A) is not particularly limited. As the (metha)acrylate oligomer (A) are mentioned urethane-based (metha)acrylate oligomers, epoxy-based (metha)acrylate oligomers, ether-based (metha)acrylate oligomers, ester-based (metha)acrylate oligomers, polycarbonate-based (metha)acrylate oligomers, fluorine-based (metha)acrylate oligomers, silicone-based (metha)acrylate oligomers and the like. Among them, the urethane-based (metha)acrylate oligomer is preferable. The (metha)acrylate oligomer can be synthesized by reacting polyethylene glycol, polyoxypropylene glycol, polytetramethylene ether glycol, bisphenol A-type epoxy resin, phenol novolac type epoxy resin, an adduct of a polyhydric alcohol with ε-caprolactone or the like with (metha)acrylic acid, or by urethanation of a polyisocyanate compound and a (metha)acrylate compound having a hydroxy group.

The urethane-based (metha)acrylate oligomer is obtained by urethanation of a polyol, an isocyanate compound and a (metha)acrylate compound having a hydroxy group. As the epoxy-based (metha)acrylate oligomer, a reaction product of a compound having a glycidyl group with (metha)acrylic acid is preferable, and a reaction product of a compound having a cyclic structure such as benzene ring, naphthalene ring, spiro-ring, dicyclopentadiene, tricyclodecane or the like and having a glycidyl group with (metha)acrylic acid is more preferable. Further, the ether-based (metha)acrylate oligomer, the ester-based (metha)acrylate oligomer and the polycarbonate-based (metha)acrylate oligomer are obtained by the reaction of respective polyol (polyether polyol, polyester polyol and polycarbonate polyol) with (metha)acrylic acid, respectively.

The molecular weight of the (metha)acrylate oligomer (A) is not particularly limited, but a weight average molecular weight is preferably not less than 4500, more preferably not less than 6000, while the weight average molecular weight is preferable to be not more than 40000. When the weight average molecular weight is not less than 4500, the elongation property can be given to the resin coating layer and the durability of the roller is improved. While, when the weight average molecular weight exceeds 40000, the tackiness of the resin coating layer is deteriorated, which may bring about the deterioration of the workability.

The (metha)acrylate monomer (B) used in the paint for the resin coating layer is a monomer having one functional group and is cured by the irradiation of ultraviolet rays and can give the elongation property to the ultraviolet-cured resin. At this moment, the functional group means acryloyloxy group (CH₂═CHCOO—) or methacryloyloxy group (CH₂═C(CH₃)COO—). If the functional group number of the (metha)acrylate monomer (B) is 2 or more, the elongation of the resin coating layer is impaired to deteriorate the durability of the roller.

The (metha)acrylate monomer (B) is preferable to have a bulky substituent or polar group in addition to the acryloyloxy group or methacryloyloxy group. When the (metha)acrylate monomer (B) has the bulky substituent or polar group, a polymer chain after the polymerization becomes sterically bulk or the interaction of the polar group in the polymer chain becomes strong, and hence the crystallinity of the polymer lowers. Since an amorphous polymer generally tends to be good in the elongation property as compared with a crystalline polymer, it is considered that the (metha)acrylate monomer (B) is effective for giving the elongation property. As the bulky substituent are mentioned substituents having a cyclic structure or a branched chain structure, and a substituent having a cyclic structure is preferable. The cyclic structure may be a monocyclic system or a polycyclic system, but it is preferable to form a rigid cyclic structure restricting the movement of the ring, and a cyclically conjugated structure such as a polycyclic crosslinking ring type structure made from three or more rings or the like is further preferable. Moreover, the cyclic structure may be a cyclic hydrocarbon or a heterocycle. As the cyclically conjugated structure are preferable benzene ring, naphthalene ring, pyridine ring and the like, while as the polycyclic crosslinking ring type structure made from three or more rings are preferable bicyclo[2.2.1]heptane ring, bicyclo[2.2.1]heptene ring, tricyclo[3.3.1.1^{3,7}]decane ring, tricyclo[5.2.1.0^{2,6}]decane ring and the like. Therefore, as the bulky substituent are concretely mentioned phenoxyethyl group, isobornyl group, norbornyl group, norbornenyl group, adamantyl group, tricyclo[5.2.1.0^{2,6}]decyl group and the like. Among them, phenoxyethyl group and isobornyl group are preferable. As the polar group is preferable a nitrogen- or oxygen-containing polar group, and are further preferable amino group, imino group, nitrile group, ammonium group, imido group, amido group, hydrazo group, azo group, diazo group, nitrogen-containing heterocyclic group and oxygen-containing heterocyclic group, and more preferable amino group, nitrogen-containing heterocyclic group and oxygen-containing heterocyclic group. Moreover, the nitrogen- or oxygen-containing polar group may further contain another heteroatom. As the amino group are preferable dialkylamino group, diarylamino group and the like. As the dialkylamino group is further preferable a dialkylamino group having an alkyl group with a carbon number of 1-10, and diethylamino group, dimethylamino group and the like are more preferable. As the diarylamino group is further preferable a diarylamino group having a non-substituted or substituted aryl group with a carbon number of 6-10 as a ring indicating an aromaticity, and diphenylamino group or the like is more preferable. As the nitrogen-containing heterocyclic group are concretely mentioned morpholino group and the like, and as the oxygen-containing heterocyclic group are concretely mentioned tetrahydrofuryl group and the like.

As the (metha)acrylate monomer (B) are preferably mentioned acryloylmorpholine, N,N-diethylaminoethyl methacrylate, isobornyl acrylate, phenoxyethyl acrylate and the like. Moreover, the (metha)acrylate monomers may be used alone or in a combination of two or more.

In the electrical conductive roller according to the invention, the paint for the resin coating layer may contains a (metha)acrylate monomer (D) other than the above (metha)acrylate monomer (B) as a reactive diluent. The (metha)acrylate monomer (D) is a monomer one or more acryloyloxy group (CH₂═CHCOO—) or methacryloyloxy group (CH₂═C(CH₃)COO—) and serves as a reactive diluent in the paint for the resin coating layer. That is, it is cured and may decrease the viscosity of the paint for the resin coating layer. The (metha)acrylate monomer (D) is preferable to have a functional group number of 1.0-10, more preferably 1.0-3.5. Also, the acrylate monomer (D) is preferable to have a molecular weight of 100-2000, more preferably 100-1000.

As the (metha)acrylate monomer (D) are mentioned 2-butyl-2-ethyl-1,3-propanediol diacrylate, 1,6-hexanediol diacrylate, isomyristyl acrylate, methoxytriethylene glycol acrylate, ethylacrylate, isobutylacrylate, n-butylacrylate, isoamylacrylate, glycidylacrylate, butoxyethyl acrylate, ethoxydiethylene glycol acrylate, methoxydipropylene glycol acrylate, 2-hydroxyethyl acrylate, 2-hydroxypropyle acrylate, pentaerythritol triacrylate and so on. Among them, 2-butyl-2-ethyl-1,3-propanediol diacrylate and 1,6-hexanediol diacrylate are preferable. These (metha)acrylate monomers (D) may be used alone or in a combination of two or more.

In the paint for the resin coating layer, a ratio of the (metha)acrylate monomer (B) occupied in a total of the (metha)acrylate oligomer (A), the (metha)acrylate monomer (B) and arbitrarily additional (metha)acrylate monomer (D) is preferable to be a range of 10-60 mass %. When the content of the (metha)acrylate monomer (B) is less than 10 mass %, the resulting ultraviolet-cured film has a tackiness and hence there is a fear of causing abrasion through friction, while when it exceeds 60 mass %, an unreacted monomer easily remains on the ultraviolet-cured film and hence bleeding of the uncured component comes into problem.

The photopolymerization initiator used in the paint for the resin coating layer has an action of starting polymerization of the above (metha)acrylate oligomer (A), (metha)acrylate monomer (B) and (metha)acrylate monomer (D) through irradiation of ultraviolet rays. As the photopolymerization initiator are mentioned 4-dimethylamino benzoic acid, 4-dimethylamino benzoic acid ester, 2,2-dimethoxy-2-phenyl acetophenone, acetophenone diethylketal, alkoxyacetophenone, benzylmethyl ketal, benzophenone; a benzophenone derivative such as 3,3-dimethyl-4-methoxy benzophenone, 4,4-dimethoxy benzophenone, 4,4-diamino benzophenone or the like; alkyl benzoylbenzoate, bis(4-dialkylaminophenyl)ketone; benzyl and a benzyl derivative such as benzylmethylketal or the like; benzoine and a benzoine derivative such as benzoine isobutyl ether or the like; benzoine isopropyl ether, 2-hydroxy-2-methylpropiophenone, 1-hydroxycyclohexyl phenylketone, xanthone; thioxanthone and a thioxanthone derivative; fluorene, 2,4,6-trimethylbenzoyl diphenyl phosphine oxide, bis(2,6-dimethoxybenzoyl)-2,4,4-trimethylpentyl phosphine oxide, bis(2,4,6-trimethylbenzoyl)-phenyl phosphine oxide, 2-methyl-1-[4-(methylthio)phenyl]-2-morpholinopropane-1,2-benzyl-2-dimethylamino-1-(morpholinophenyl)-butanone-1 and so on. These photopolymerization initiators may be used alone or in a combination of two or more. The amount of the photopolymerization initiator (C) compounded in the paint for the resin coating layer is preferable to be a range of 0.2-5.0 parts by mass per 100 parts by mass in total of the above oligomer and monomers. When the amount of the photopolymerization initiator (C) is less than 0.2 parts by mass, the effect of starting the ultraviolet curing of the paint for the resin coating layer is small, while when it exceeds 5.0 parts by mass, the effect of starting the ultraviolet curing is saturated and the cost becomes higher.

In the paint for the resin coating layer, in order to promote the polymerization reaction through the photopolymerization initiator (C), a tertiary amine-based photopolymerization promoter such as triethylamine, triethanolamine or the like, a phosphine-based photopolymerization promoter such as triphenyl phosphine or the like, a thioether-based photopolymerization promoter such as thiodiglycol or the like, and so on may be further added to the paint. The amount of the photopolymerization promoter added is preferable to be a range of 0.01-10 parts by mass per 100 parts by mass in total of the above oligomer and monomers.

In the electrical conductive roller according to the invention, the paint for the resin coating layer comprises the above (metha)acrylate oligomer (A), (metha)acrylate monomer (B), photopolymerization initiator (C) and arbitrarily included (metha)acrylate monomer (D) and photopolymerization promoter and is preferable to further contain an electrically conducting agent, fine particles, a polymerization inhibitor and the like. Moreover, the resin coating layer(s) other than the resin coating layer adjacent to the elastic layer in the electrical conductive roller according to the invention is not particularly limited, and may be the same or different from the resin coating layer adjacent to the elastic layer.

The electrical conductive roller according to the invention comprises the resin coating layer on the outer peripheral surface of the elastic layer for the purpose of increasing the hardness of the roller, controlling the charging property to toners or the adhesiveness, reducing friction force to the photosensitive drum, a stratification blade or the like, or preventing the contamination of the photosensitive drum or the like through the elastic layer. And, the resin coating layer in the electrical conductive roller according to the invention is not particularly limited as long as it has specified glass transition point (Tg) and friction coefficient, but is preferable to contain fine particles, a ultraviolet curing resin, a fluorine-containing resin and compound, a silicon-containing resin and compound, and so on, and may contain well-known additives, if necessary.

The resin coating layer in the electrical conductive roller according to the invention preferably contains fine particles. By including the fine particles into the resin coating layer is properly formed fine unevenness on the surface of the electrical conductive roller to decrease an area of a portion contacting with toners, other adjoining member or the like, whereby the friction coefficient can be reduced. As the fine particles are preferable fine particles of rubber or synthetic resin and inorganic fine particles such as fine carbon particles, fine silica particles and the like, and particularly fine particles of silicone rubber, silicone resin, fluorine resin, urethane resin, polyolefin resin, epoxy resin, polystyrene resin, urethane acrylate, melamine resin, phenolic resin, (metha)acryl resin or vitreous carbon and fine silica particles are preferable. These fine particles may be used alone or in a combination of two or more. Moreover, the fine particles are preferable to be compounded in the paint liquid used for the formation of the resin coating layer. Further, the amount of the fine particles is preferable to be a range of 0.1-100 parts by mass, more preferably a range of 5-80 parts by mass per 100 parts by mass of the resin constituting the resin coating layer.

The average particle size of the fine particles is preferably 1-50 μm, more preferably 3-20 μm. Also, a ratio (a/b) of average particles size a of the finer particles to thickness b of the resin coating layer is preferably a range of 0.03-5.0, more preferably 0.1-5.0. When the ratio a/b is within a range of 0.03-5.0, proper fine unevenness can be formed on the surface of the resin coating layer.

The resin coating layer in the electrical conductive roller according to the invention is preferable to contain at least one of fluorine-containing resin, fluorine-containing compound, silicon-containing resin and silicon-containing compound. The resin coating layer containing the fluorine-containing resin and compound or the silicon-containing resin and compound is formed by applying either one of (1) a paint liquid containing at least one selected from the group consisting of ultraviolet-polymerizable fluorine-containing resin and compound and silicon-containing resin and compound, (2) a paint liquid containing at least one selected from the group of ultraviolet non-curable fluorine-containing resin and compound and silicon-containing resin and compound and a ultraviolet-polymerizable resin and/or compound containing no fluorine and silicon and (3) a paint liquid containing at least one selected from the group of ultraviolet non-curable fluorine-containing resin and compound and silicon-containing resin and compound and at least one selected from the group consisting of ultraviolet-polymerizable fluorine-containing resin and compound and silicon-containing resin and compound on the outer surface of the elastic layer and then irradiating ultraviolet rays to cure the ultraviolet-polymerizable resin and/or compound (i.e. ultraviolet-polymerizable fluorine-containing resin and/or compound and silicon-containing resin and/or compound, and resin and/or compound containing no fluorine and silicon). By including at least one selected from the group consisting of fluorine-containing resin and compound and silicon-containing resin and compound (which may be ultraviolet-curable or ultraviolet non-curable) into the resin coating layer is further reduced the friction force of the resin coating layer, whereby the printing durability of the electrical conductive roller can be improved. At this moment, the ultraviolet-polymerizable resin and/or compound are preferable to have a ultraviolet-polymerizable carbon-carbon double bond.

The total content of fluorine and silicon in the resin coating layer is preferably a range of 0.1-50 mass %, more preferably a range of 0.5-30 mass %. When the total content of fluorine and silicon in the resin coating layer is less than 0.1 mass %, the properties of fluorine and silicon are not developed sufficiently and hence the printing durability may be lacking, while when it exceeds 50 mass %, the adhesiveness between the resin coating layer and the underlayer thereof is deteriorated or the solubility and dispersibility may be deteriorated.

As the resin and/or compound having a ultraviolet-polymerizable carbon-carbon double bond and containing no fluorine and silicon are preferable (metha)acrylate monomers and oligomers containing no fluorine and silicon, which include, for example, monomers and oligomers of urethane-based (metha)acrylate, epoxy-based (metha)acrylate, ether-based (metha)acrylate, ester-based (metha)acrylate, polycarbonate-based (metha)acrylate and the like. These (metha)acrylate oligomers can be synthesized as previously mentioned.

As the resin and/or compound having a ultraviolet-polymerizable carbon-carbon double bond and containing fluorine are preferable compounds derived from fluoroolefins, and fluoro(metha)acrylates. The fluorine-containing resin and/or compound having a ultraviolet-polymerizable carbon-carbon double bond may be a monomer or an oligomer or a mixture of monomer and oligomer. And, the fluorine content in the fluorine-containing resin and/or compound having a polymerizable carbon-carbon double bond is preferably a range of 0.05-80 mass %, more preferably a range of 0.08-80 mass %, further preferably a range of 0.1-80 mass %.

As the fluoroolefin used for the formation of the compound derived from the fluoroolefin are olefins having a carbon number of 2-12 wherein one or more hydrogen atoms are replaced with fluorine, and are concretely mentioned vinyl fluoride [CFH═CH₂, fluorine content: 41 mass %], vinylidene fluoride [CF₂═CH₂, fluorine content: 59 mass %], trifluoroethylene [CF₂═CFH, fluorine content: 70 mass %], tetrafluoroethylene [CF₂═CF₂, fluorine content: 76 mass %], hexafluoropropene [CF₃CF═CF₂, fluorine content: 76 mass %], (perfluorobutyl)ethylene [CF₃(CF₂)₃CH═CH₂, fluorine content: 69 mass %], (perfluorohexyl)ethylene [CF₃(CF₂)₅CH═CH₂, fluorine content: 71 mass %], (perfluorooctyl)ethylene [CF₃(CF₂)₇CH═CH₂, fluorine content: 72 mass %], (perfluorodecyl)ethylene [CF₃(CF₂)₉CH═CH₂, fluorine content: 73 mass %], chlorotrifluoroethylene [CF₂═CFCl, fluorine content: 49 mass %], 1-methoxy-(perfluoro-2-methyl-1-propene) [(CF₃)₂C═CFOCH₃, fluorine content: 63 mass %], 1,4-divinyloctafluoro butane [CH₂═CH—(CF₂)₄—CH═CH₂, fluorine content: 60 mass %], 1,6-divinyldodecafluoro hexane [CH₂═CH—(CF₂)₆—CH═CH₂, fluorine content: 64 mass %], 1,8-divinylhexadecafluoro octane [CH₂═CH—(CF₂)₈—CH═CH₂, fluorine content: 67 mass %] and so on.

As the fluoro(metha)acrylate are preferable alkyl (metha)acrylates having a carbon number of 5-16 wherein one or more hydrogen atoms are replaced with fluorine, and are concretely mentioned 2,2,2-trifluoroethyl acrylate [CF₃CH₂OCOCH═CH₂, fluorine content: 37 mass %], 2,2,3,3,3-pentafluoropropyl acrylate [CF₃CF₂CH₂OCOCH═CH₂, fluorine content: 47 mass %], 2-(perfluorobutyl)ethyl acrylate [CF₃(CF₂)₃CH₂CH₂OCOCH═CH₂, fluorine content: 54 mass %], 3-(perfluorobutyl)-2-hydroxypropyl acrylate [CF₃(CF₂)₃CH₂CH(OH)CH₂OCOCH═CH₂, fluorine content: 49 mass %], 2-(perfluorohexyl)ethyl acrylate [CF₃(CF₂)₅CH₂CH₂OCOCH═CH₂, fluorine content: 59 mass %], 3-(perfluorohexyl)-2-hydroxypropyl acrylate [CF₃(CF₂)₅CH₂CH(OH)CH₂OCOCH═CH₂, fluorine content: 55 mass %], 2-(perfluorooctyl)ethyl acrylate [CF₃(CF₂)₇CH₂CH₂OCOCH═CH₂, fluorine content: 62 mass %], 3-(perfluorooctyl)-2-hydroxypropyl acrylate [CF₃(CF₂)₇CH₂(OH)CH₂OCOCH═CH₂, fluorine content: 59 mass %], 2-(perfluorodecyl)ethyl acrylate [CF₃(CF₂)₉CH₂CH₂OCOCH═CH₂, fluorine content: 65 mass %], 2-(perfluoro-3-methylbutyl)ethyl acrylate [(CF₃)₂CF(CF₂)₂CH₂CH₂OCOCH═CH₂, fluorine content: 57 mass %], 3-(perfluoro-3-methylbutyl)-2-hydroxypropyl acrylate [(CF₃)₂CF(CF₂)₂CH₂CH(OH)CH₂OCOCH═CH₂, fluorine content: 52 mass %], 2-(perfluoro-5-methylhexyl)ethyl acrylate [(CF₃)₂CF(CF₂)₄CH₂CH₂OCOCH═CH₂, fluorine content: 61 mass %], 3-(perfluoro-5-methylhexyl)-2hydroxypropyl acrylate [(CF₃)₂CF(CF₂)₄CH₂CH(OH)CH₂OCOCH═CH₂, fluorine content: 57 mass %], 2-(perfluoro-7-methyloctyl)ethyl acrylate [(CF₃)₂CF(CF₂)₆CH₂CH₂OCOCH═CH₂, fluorine content: 64 mass %], 3-(perfluoro-7-methyloctyl)-2-hydroxypropyl acrylate [(CF₃)₂CF(CF₂)₆CH₂CH(OH)CH₂OCOCH═CH₂, fluorine content: 60 mass %], 1H,1H,3H-tetrafluoropropyl acrylate [CHF₂CF₂CH₂OCOCH═CH₂, fluorine content: 41 mass %], 1H,1H,5H-octafluoropentyl acrylate [CHF₂(CF₂)₃CH₂OCOCH═CH₂, fluorine content: 53 mass %], 1H,1H,7H-dodecafluoroheptyl acrylate [CHF₂(CF₂)₅CH₂OCOCH═CH₂, fluorine content: 59 mass %], 1H,1H,9H-hexadecafluorononyl acrylate [CHF₂(CF₂)₇CH₂OCOCH═CH₂, fluorine content: 63 mass %], 1H-1-(trifluoromethyl)trifluoroethyl acrylate [(CF₃)₂CHOCOCH═CH₂, fluorine content: 51 mass %], 1H,1H,3H-hexafluorobutyl acrylate [CF₃CHFCF₂CH₂OCOCH═CH₂, fluorine content: 48 mass %], 2,2,2-trifluoroethyl methacrylate [CF₃CH₂OCOC(CH₃)═CH₂, fluorine content: 34 mass %], 2,2,3,3,3-pentafluoropropyl methacrylate [CF₃CF₂CH₂OCOC(CH₃)═CH₂, fluorine content: 44 mass %], 2-(perfluorobutyl)ethyl methacrylate [CF₃(CF₂)₃CH₂CH₂OCOC(CH₃)═CH₂, fluorine content: 51 mass %], 3-(perfluorobutyl)-2-hydroxypropyl methacrylate [CF₃(CF₂)₃CH₂CH(OH)CH₂OCOC(CH₃)═CH₂, fluorine content: 47 mass %], 2-(perfluorohexyl)ethyl methacrylate [CF₃(CF₂)₅CH₂CH₂OCOC(CH₃)═CH₂, fluorine content: 57 mass %], 3-(perfluorohexyl)-2-hydroxypropyl methacrylate [CF₃(CF₂)₅CH₂CH(OH)CH₂OCOC(CH₃)═CH₂, fluorine content: 53 mass %], 2-(perfluorooctyl)ethyl methacrylate [CF₃(CF₂)₇CH₂CH₂OCOC(CH₃)═CH₂, fluorine content: 61 mass %], 3-perfluorooctyl-2-hydroxypropyl methacrylate [CF₃(CF₂)₇CH₂CH(OH)CH₂OCOC(CH₃)═CH₂, fluorine content: 57 mass %], 2-(perfluorodecyl)ethyl methacrylate [CF₃(CF₂)_{g}CH₂CH₂OCOC(CH₃)═CH₂, fluorine content: 63 mass %], 2-(perfluoro-3-methylbutyl)ethyl methacrylate [(CF₃)₂CF(CF₂)₂CH₂CH₂OCOC(CH₃)═CH₂, fluorine content: 55 mass %], 3-(perfluoro-3-methylbutyl)-2-hydroxypropyl methacrylate [(CF₃)₂CF(CF₂)₂CH₂CH(OH)CH₂OCOC(CH₃)═CH₂, fluorine content: 51 mass %], 2-(perfluoro-5-methylhexyl)ethyl methacrylate [(CF₃)₂CF(CF₂)₄CH₂CH₂OCOC(CH₃)═CH₂, fluorine content: 59 mass %], 3-(perfluoro-5-methylhexyl)-2-hydroxypropyl methacrylate [(CF₃)₂CF(CF₂)₄CH₂CH(OH)CH₂OCOC(CH₃)═CH₂, fluorine content: 56 mass %], 2-(perfluoro-7-methyloctyl)ethyl methacrylate [(CF₃)₂CF(CF₂)₆CH₂CH₂OCOC(CH₃)═CH₂, fluorine content: 62 mass %], 3-(perfluoro-7-methyloctyl)-2-hydroxypropyl methacrylate [(CF₃)₂CF(CF₂)₆CH₂CH(OH)OCOC(CH₃)═CH₂, fluorine content: 59 mass %], 1H,1H,3H-tetrafluoropropyl methacrylate [CHF₂CF₂CH₂OCOC(CH₃)═CH₂, fluorine content: 51 mass %], 1H, 1H,5H-octafluoropentyl methacrylate [CHF₂(CF₂)₃CH₂OCOC(CH₃)═CH₂, fluorine content: 51 mass %], 1H,1H,7H-dodecafluoroheptul methacrylate [CHF₂(CF₂)₅CH₂OCOC(CH₃)═CH₂, fluorine content: 57 mass %], 1H, 1H,9H-hexadecafluorononyl methacrylate [CHF₂(CF₂)₇CH₂OCOC(CH₃)═CH₂, fluorine content: 61 mass %], 1H-1-(trifluoromethyl)trifluoroethyl methacrylate [(CF₃)₂CHOCOC(CH₃)═CH₂, fluorine content: 48 mass %], 1H,1H,3H-hexafluorobutyl methacrylate [CF₃CHFCF₂CH₂OCOC(CH₃)═CH₂, fluorine content: 46 mass %] and so on.

As the silicon-containing resin and/or compound having a ultraviolet-polymerizable carbon-carbon double bond are preferable both terminal reactive silicon oils, one terminal reactive silicone oils, and (metha)acryloxy alkylsilanes. As the reactive silicone oil are preferable ones obtained by introducing (metha)acryl group into terminal(s). Moreover, the silicon content of the silicon-containing resin and/or compound having a polymerizable carbon-carbon double bond is preferably a range of 0.01-40 mass %, more preferably a range of 0.05-35 mass %, further preferably 0.1-30 mass %.

As the both terminal reactive silicone oil are mentioned silicone oils represented by the following formula (I):

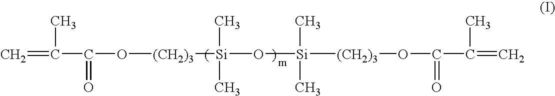

(wherein m is a repetitive unit number). As the both terminal reactive silicone oil may be used commercially available ones, which include, for example, trade name “X-22-164A” (viscosity: 25 mm²/s, functional group equivalent: 860 g/mol), trade name “X-22-164B” (viscosity: 55 mm²/s, functional group equivalent: 1630 g/mol) and trade name “X-22-164C” (viscosity: 90 mm²/s, functional group equivalent: 2370 g/mol), which are made by Shin-Etsu Chemical Co., Ltd. and trade name “BX16-152B” (viscosity: 40 cs/25° C., methacryl group equivalent: 1300 g/mol, specific gravity as 25° C.: 0.9), trade name “BY16-152” (viscosity: 85 cs/25° C., methacryl group equivalent: 2800 g/mol, specific gravity at 25° C.: 0.97) and trade name “BX2-152C” (viscosity: 330 cs/25° C., methacryl group equivalent: 5100 g/mol, specific gravity at 25° C.: 0.97), which are made of Toray Dow-Corning Silicon Co., Ltd. and so on.

As the one terminal reactive silicone oil are mentioned a silicone oil represented by the following equation (II):

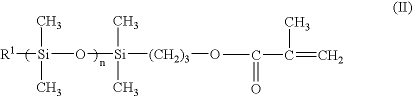

(wherein R¹ is a methyl group or a butyl group and n is a repetitive unit number) and a silicone oil represented by the following equation (III):

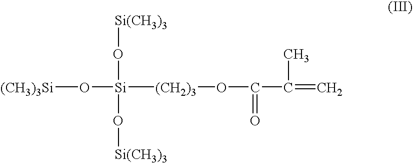

As the one terminal reactive silicone oil may be used commercially available ones, which may include, for example, trade name “X-24-8201” (viscosity: 25 mm²/s, functional group equivalent: 2100 g/mol), trade name “X-22-174DX” (viscosity: 60 mm²/s, functional group equivalent: 4600 g/mol) and trade name “X-22-2426” (viscosity: 180 mm²/s, functional group equivalent: 12000 g/mol), which are made by Shin-Etsu Chemical Co., Ltd. and trade name “BX16-122A” (viscosity: 5 cs/25° C., refractive index: 1.417, specific gravity at 25° C.: 0.92) made by Toray Dow-Corning Silicon Co., Ltd. and so on.

As the (metha)acryloxy alkylsilane are mentioned 3-methacryloxypropyl dichloromethylsilane [CH₂═C(CH₃)COO(CH₂)₃SiCl₂CH₃], 3-acryloxypropyl dimethoxymethylsilane [CH₂═CHCOO(CH₂)₃Si(OCH₃)₂CH₃], 3-acryloxypropyl trimethoxysilane [CH₂═CHCOO(CH₂)₃Si(OCH₃)₃], 3-methacryloxypropyl dimethoxymethylsilane [CH₂═C(CH₃)COO(CH₂)₃Si(OCH₃)₂CH₃], 3-methacryloxypropyl trimethoxysilane [CH₂═C(CH₃)COO(CH₂)₃Si(OCH₃)₃], 3-methacryloxypropyl diethoxymethylsilane [CH₂═C(CH₃)COO(CH₂)₃Si(OC₂H₅)₂CH₃], 3-methacryloxypropyl triethoxysilane [CH₂═C(CH₃)COO(CH₂)₃Si(OC₂H₅)₃] and so on. As the (metha)acryloxy alkylsilane may be used commercially available ones, which include, for example, trade names “LS-2080”, “LS-2826”, “LS-2827”, “LS-3375”, “LS-3380”, “LS-4548”, “LS-5118” and the like made by Shin-Etsu Chemical Co., Ltd.

On the other hand, when at least one selected from the group consisting of ultraviolet non-curable fluorine-containing resin and compound and silicon-containing resin and compound is used in the resin coating layer are ultraviolet non-curable fluorine-containing resin and compound and silicon-containing resin and compound dispersing or dissolving in the paint liquid. As the ultraviolet non-curable fluorine-containing resin and/or compound are concretely mentioned fluorine-containing (metha)acrylate-based resin and/or compound, fluorine-containing olefin-based resin and/or compound, fluorine-containing ether-based resin and/or compound, fluorine-containing ester-based resin and/or compound, fluorine-containing epoxy-based resin and/or compound and fluorine-containing urethane-based resin and/or compound. As the ultraviolet non-curable silicon-containing resin and/or compound are concretely mentioned silicon-containing (metha)acrylate-based resin and compound having plural siloxane bonds, silicone resin, alkoxysilanes and polymers thereof. These ultraviolet non-curable fluorine-containing resins and compounds and silicon-containing resins and compounds may be used alone or in a combination of two or more. Moreover, the fluorine-containing resin and compound and the silicon-containing resin and compound are bad in the compatibility with the elastic layer and poor in the adhesiveness to the elastic layer as compared with the resin containing no fluorine and silicon, but when at least one selected from the group consisting of the ultraviolet non-curable fluorine-containing resin and compound and silicon-containing resin and compound and a ultraviolet-curable resin containing no fluorine and silicon are included in the resin coating layer, since the surface energy of the ultraviolet non-curable fluorine-containing resin and compound and silicon-containing resin and compound is smaller than the surface energy of the ultraviolet-curable resin containing no fluorine and silicon, there is a tendency that the ultraviolet non-curable fluorine and/or silicon-containing resin and/or compound is eccentrically located at the surface side of the resin coating layer (i.e. side not contacting with the elastic layer), and hence the content of the ultraviolet non-curable fluorine and/or silicon-containing resin and/or compound in the side of the resin coating layer contacting with the elastic layer is decreased and the adhesiveness between the resin coating layer and the elastic layer is improved. As a result that the ultraviolet non-curable fluorine and/or silicon-containing resin and/or compound is eccentrically located at the surface side of the resin coating layer, the releasability of the resin coating layer to toners is improved and also the printing durability is improved. Even if the total content of the ultraviolet non-curable fluorine and/or silicon-containing resin and/or compound in the resin coating layer is decreased, since the ultraviolet non-curable fluorine and/or silicon-containing resin and/or compound is eccentrically located at the surface side of the resin coating layer, the releasability of the resin coating layer to toners can be maintained sufficiently but also it is possible to decrease the total content of the expensive fluorine and/or silicon-containing resin and/or compound while improving the adhesiveness between the resin coating layer and the elastic layer.

The fluorine content of the ultraviolet non-curable fluorine-containing resin and/or compound is preferably a range of 2-80 mass %, more preferably 2-70 mass %. When the fluorine content of the ultraviolet non-curable fluorine-containing resin and/or compound is less than 2 mass %, the effect of fluorine is insufficient, while when it exceeds 80 mass %, there is a problem in the compatibility and dispersibility. Also, the silicon content of the ultraviolet non-curable silicon-containing resin and/or compound is preferably a range of 2-70 mass %, more preferably a range of 2-50 mass %. When the silicon content of the ultraviolet non-curable silicon-containing resin and/or compound is less than 2 mass %, since the silicon content becomes lower, the aimed performances may not be developed, while when it exceeds 70 mass %, the compatibility may be deteriorated or the dispersibility may be deteriorated undesirably.

As the ultraviolet non-curable fluorine-containing (metha)acrylate-based resin are mentioned homopolymers of fluorine-containing (metha)acrylate such as perfluoroalkyl ester and partially fluorinated alkyl ester of (metha)acrylic acid, (metha)acrylic acid ester formed by connecting perfluoroalkyl groups or partially fluorinated alkyl groups through an organic connecting group; copolymers of the fluorine-containing (metha)acrylate with (metha)acrylate containing no fluorine such as an ester of (metha)acrylic acid with an alkyl group such as methyl, ethyl, butyl, octyl, dodecyl or the like; a hydroxyalkyl ester such as hydroxybutyl or the like; a glycidyl ester or the like. Such a copolymer may be further copolymerized with a small amount of polysiloxane group-containing (metha)acrylate. At this moment, the carbon number in the perfluoroalkyl group or partially fluorinated alkyl group of the fluorine-containing (metha)acrylate is preferable to be a range of 1-20. As the fluorine-containing (metha)acrylate is preferable a compound represented by the following formula (IV):

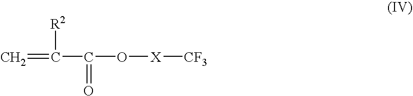

(wherein X is an alkylene group, perfluoroalkylene group or partially fluorinated alkylene group having a carbon number of 1-20, which may be straight chain or branched chain and further an oxygen atom may be incorporated into a main chain or a side chain of the alkylene group, perfluoroalkylene group or partially fluorinated alkylene group; and R2 is hydrogen, methyl group, chlorine, fluorine or cyano group). From a viewpoint of improving the durability of the resin coating layer, X in the formula (IV) is preferably an alkylene group, perfluoroalkylene group or partially fluorinated alkylene group having a carbon number of not less than 4, more preferably an alkylene group, perfluoroalkylene group or partially fluorinated alkylene group having a carbon number of not less than 6, further preferably —(CH₂)₂—(CF₂)₇—.

The ultraviolet non-curable fluorine-containing (metha)acrylate-based resin may have a cross-linkable functional group in its molecule. As the cross-linkable functional group, mention may be made of hydroxy group, thiol group, carboxyl group, amino group, isocyanate group, aziridinyl group, glycidyl group, alkoxysilyl group, silanol group, cyclocarbonate group, acid anhydride group, vinyl group, enolether group, thioether group, active ester group, acetoacetate group, metal salt, metal oxide, functional group blocked with various blocking agents thereof, and so on. As a compound reacting with the cross-linkable functional group can be used reactive polyfunctional compounds having two or more reacting functional groups in their molecules. As the reactive functional group are mentioned functional groups similar to the above cross-linkable functional groups. As the reactive polyfunctional compound are preferable organic epoxy compounds and organic polyisocyanate compounds from a viewpoint of industrial utility.

As the organic epoxy compound are mentioned compounds having two or more glycidyl groups, which include concretely ethylene glycol diglycidyl ether, propylene glycol diglycidyl ether, glycerol polyglycidyl ether, diglycerol polyglycidyl ether, sorbitol polyglycidyl ether, polyethylene glycol diglycidyl ether, tripropylene glycol diglycidyl ether, polypropylene glycol diglycidyl ether, neopentylglycol diglycidyl ether, 1,6-hexanediol dilycidyl ether, glycerin polyglycidyl ether, diglycerin polyglycidyl ether, trimethylol propane polyglycidyl ether, spiroglycol diglycidyl ether, various epoxy resins and so on.

As the organic polyisocyanate compound are concretely mentioned 2,4-tolylene diisocyanate, 2,6-tolylene diisocyanate, m-phenylene diisocyanate, p-phenylene diisocyanate, 4,4′-diphenylmethane diisocyanate, 2,4′-diphenylmetane diisocyanate, 2,2′-diphenylmetane diisocyanate, 3,3′-dimethyl-4,4′-biphenylene diisocyanate, 3,3′-dimethoxy-4,4′-phenylene diisocyanate, 3,3′-dichloro-4,4′-biphenylene diisocyanate, 1,5-naphthalene diisocyanate, 1,5-tetrahydronaphthalene diisocyanate, tetramethylene diisocyanate, 1,6-hexamethylene diisocyanate, dodecamethylene diisocyanate, trimethylhexamethylene diisocyanate, 1,3-cyclohexylene diisocyanate, 1,4-cyclohexylene diisocyanate, xylylene diisocyanate, tetramethylxylylene diisocyanate, hydrogenated xylylene diisocyanate, lysine diisocyanate, isophorone diisocyanate, 4,4′-dicyclohexylmethane diisocyanate, 3,3′-dimethyl-4,4′-dicyclohexylmetane diisocyanate and the like as well as dimers and trimers thereof and polyisocyanates wherein isocyanate group in these compounds is partly blocked with phenol, oxim, alcohol, active methylene, mercaptan, acid amid, imide, amine, imidazole, urea, carbamic acid salt, imine or sulfite.

As the ultraviolet non-curable fluorine-containing olefin-based resin are concretely mentioned polyvinylidene fluoride, polytetrafluoroethylene, vinylidene fluoride-tetrafluoroethylene copolymer, ethylene-tetrafluoroethylene copolymer, vinylidene fluoride-tetrafluoroethylene-hexafluoropropylene terpolymer, tetrafluoroethylene-hexafluoropropylene copolymer, vinylidene fluoride-hexafluoropropylene copolymer, polyvinyl fluoride, polyvinyl fluoride ether, vinyl fluoride ether-tetrafluoroethylene copolymer and so on. The fluorine-containing polyolefin-based resin is obtained by polymerizing or copolymerizing fluorine-containing olefinic monomer(s) such as vinyl fluoride, vinylidene fluoride, tetrafluoroethylene, hexafluoropropylene, vinyl fluoride ether and the like.

As the ultraviolet non-curable silicon-containing (metha)acrylate-based resin are mentioned a homopolymer of silicon-containing (metha)acrylate such as polysiloxane group-containing (metha)acrylate or the like; a copolymer of the silicon-containing (metha)acrylate with a (metha)acrylate containing no silicon such as an alkyl ester such as methyl, ethyl, butyl, octyl, dodecyl or the like of (metha)acrylic acid, hydroxyalkyl ester such as hydroxyethyl, hydroxybutyl or the like, or glycidylester or the like. This copolymer may be further copolymerized with a small amount of a fluorine-containing (metha)acrylate such as perfluoroalkyl ester and partially fluorinated alkyl ester of (metha)acrylic acid, (metha)acrylic acid ester wherein perfluoroalkyl groups or partially fluorinated alkyl groups are connected through an organic connecting group, or the like. As the polysiloxane group-containing (metha)acrylate are mentioned (metha)acrylic acid ester wherein (metha)acryloyl group is connected to one terminal or both terminals of polysiloxane chain through a bivalent connecting group, and the like.

The ultraviolet non-curable silicone resin is a polymer having a three-dimensional network structure obtained by hydrolyzing and polymerizing, for example, an organochlorosilane, and is produced by using three functional monomer such as methyltrichlorosilane, phenyltrichlorosilane or the like as a main monomer and arbitrarily combining with two-functional monomer such as dimethyldichlorosilane, diphenyldichlorosilane or the like and a monofunctional monomer such as chlorosilane or the like. Also, there can be used a modified silicone resin obtained by alkyd modification, polyester modification, epoxy modification, phenol modification or the like of the silicone resin. Furthermore, as the ultraviolet non-curable silicon-containing resin and/or compound may be used silicates such as alkoxysilanes (silicic ester) and polymers obtained by polymerization thereof. These ultraviolet non-curable silicon-containing resins and/or compounds may be used alone or in a combination of two or more.

The paint for the resin coating layer according to the invention may contain an electrically conducting agent for the purpose of giving the electric conductivity. As the electrically conducting agent are mentioned the same as used in the elastic layer.

Also, the paint for the resin coating layer according to the invention may further contain a polymerization inhibitor. By adding the polymerization inhibitor can be prevented thermal polymerization before the irradiation of ultraviolet rays. As the polymerization inhibitor are mentioned hydroquinone, hydroquinone monomethyl ether, p-methoxyphenol, 2,4-dimethyl-6-t-butylphenol, 2,6-di-t-butyl-p-cresol, butylhydroxy anisole, 3-hydroxy thiophenol, α-nitroso-β-nathphtol, p-benzoquinone, 2,5-dihydroxy-p-quinone and the like. Moreover, the content of the polymerization inhibitor is preferable to be a range of 0.001-0.2 part by mass per 100 parts by mass inn total of the oligomer and monomer.

In the electrical conductive roller according to the invention, the ultraviolet cured resin forming the resin coating layer adjacent to the elastic layer is required to have an elongation at break of not less than 80%. When the elongation at break of the ultraviolet cured resin is less than 80%, the elongation of the resin coating layer is damaged to deteriorate the durability of the roller and hence the chipping of the resin coating layer is caused during the printing.

In the ultraviolet cured resin forming the resin coating layer, an elastic modulus is made to not more than 280 MPa in addition to the elongation at break of not less than 80%, whereby the durability of the electrical conductive roller can be further improved. When the elastic modulus exceeds 280 MPa, stress is concentrated into the resin coating layer to deteriorate the durability of the roller and hence the chipping of the resin coating layer is caused during the printing.

The resin coating layer is preferable to have a thickness in total of 0.5-200 μm. When the thickness in total of the resin coating layer is less than 0.5 μm, the effect of arranging the resin coating layer is small, while when it exceeds 200 μm, the surface of the electrical conductive roller becomes hard to deteriorate the flexibility and also the weight is increased and the coat is also increased. Moreover, if the resin coating layer is a single layer, the thickness is preferably 0.5-50 μm, particularly 0.8-20 μm. In case of the multi-layer, the total thickness is 0.8-200 μm, preferably 5-20 μm, and the thickness of the individual layer is preferably 0.5-50 μm.

The manufacture of the electrical conductive roller according to the invention is not particularly limited, and can be manufactured, for example, by preparing a paint for the resin coating layer containing components for the formation of the resin coating layer and applying it onto the elastic layer of the roller body obtained by the aforementioned method and then irradiating ultraviolet rays to form the resin coating layer. Also, the electrical conductive roller having two or more resin coating layers can be manufactured by repeating the same procedure as mentioned above. As a result, the electrical conductive roller according to the invention does not require the long drying line in the production and has the resin coating layer of a stable quality. Moreover, As a method of applying the paint for the resin coating layer onto the outer surface of the elastic layer or the resin coating layer are mentioned a spraying method, a method using a roll coater, a dipping method, a die coating method and the like. As a light source used in the irradiation of ultraviolet rays are mentioned a mercury lamp, a high pressure mercury lamp, a super-high pressure mercury lamp, a metal halide lamp, a xenon lamp and the like. The conditions for the irradiation of ultraviolet rays are properly selected in accordance with the components included in each paint, an amount of the paint applied and the like, and the irradiation intensity, integrating light quantity and the like may be adjusted properly.

The electrical conductive roller according to the invention can be used as a developing roller, a charge roller, a toner feed roller, a transfer roller, a paper feed roller, a cleaning roller, a pressing fuser roller or the like in an imaging apparatus. Particularly, the electrical conductive roller according to the invention is preferably used as a developing roller.

<Imaging Apparatus>

The imaging apparatus according to the invention is characterized by comprising the aforementioned electrical conductive roller. The imaging apparatus according to the invention is not particularly limited as long as it has the electrical conductive roller and can be produced by a well-known method.

The imaging apparatus according to the invention will be described in detail with reference to FIG. 2 below. FIG. 2 is a partial sectional view of an embodiment of the imaging apparatus according to the invention. The illustrated imaging apparatus comprises a photosensitive drum 5 carrying an electrostatic latent image, a charge roller 6 positioned near to the photosensitive drum 5 (upside in the figure) for charging the photosensitive drum 5, a toner feed roller 8 for supplying toners 7, a developing roller 9 disposed between the toner feed roller 8 and the photosensitive drum 5, a stratification blade 10 disposed near to the developing roller 9 (upside in the figure), a transfer roller 11 positioned near to the photosensitive drum 5 (downside in the figure), and a cleaning roller 12 disposed adjacent to the photosensitive drum 5. Moreover, the imaging apparatus according to the invention may further comprise known members (not shown) usually used for the imaging apparatus.

In the illustrated imaging apparatus, the charge roller 6 is contacted with the photosensitive drum 5, and a voltage is applied between the photosensitive drum 5 and the charge roller 6 to charge the photosensitive drum 5 at a constant electric potential, and then an electrostatic latent image is formed on the photosensitive drum 5 by an exposure machine (not shown). Then, the toners 7 are supplied from the toner feed roller 8 to the photosensitive drum 5 through the developing roller 9 by rotating the photosensitive drum 5, the toner feed roller 8 and the developing roller 9 in the direction shown by arrows in the figure. The toners 7 on the developing roller 9 are made to be a uniform thin layer by the stratification blade 10, while since the developing roller 9 and the photosensitive drum 5 are rotated in contact with each other, the toners 7 are attached from the developing roller 9 to the electrostatic latent image on the photosensitive drum 5 to visualize the latent image. The toners 7 attached to the latent image are transferred to a recording medium such as a paper or the like by the transfer roller 11, while the remaining toners 7 on the photosensitive drum 5 after the transferring are removed by the cleaning roller 12. In the imaging apparatus according to the invention, it is possible to stably form an excellent image by using the aforementioned electrical conductive roller 1 comprising the elastic layer 3 and the resin coating layer 4 and having an excellent durability as at least one of the charge roller 6, the toner feed roller 8, the developing roller 9, the transfer roller 11 and the cleaning roller 12.

The following examples are given in illustration of the invention and are not intended as limitations thereof.

Firstly, a roller body having an elastic layer with a specification common to Examples 1-14 and Comparative Examples 1-6 is prepared according to the following formulation.

(Preparation of Roller Body)

A polyurethane starting material is prepared by mixing 100 parts by mass of a polyol-modified tolylene diisocyanate having a NCO content of 6.7% by prepolymerization of a polyether polyol as an isocyanate component, 2.0 parts by mass of a conductive carbon black, 21 parts by mass of polyether polyol having a hydroxy value of 37.0 mgKOH/g and an average functional group number of 3, 19 parts by mass of polyether polyol having a hydroxy value of 388 mgKOH/g and an average functional group number of 3, 5 parts by mass of a reactive silicone foam stabilizer (polydimethyl siloxane/polyethylene oxide copolymer) having a hydroxy value of 34 mgKOH/g, 0.3 part by mass of sodium perchlorate and 0.2 part by mass of dibutyltin dilaurate. The polyurethane starting material is expanded by a mechanical froth method. The expanded polyurethane starting material is poured in a mold set with a metal shaft to prepare a roller body having an elastic layer of a urethane foam about the periphery of the shaft. Moreover, the expansion ratio of the thus obtained urethane foam is 1.6 times.

### EXAMPLES 1-14 AND COMPARATIVE EXAMPLES 1-6

A paint for a resin coating layer having a compounding recipe as shown in Tables 1-3 is applied onto the surface of the roller body through a roll coater and then ultraviolet rays are irradiated at a ultraviolet irradiating intensity of 1500 mW/cm² for 5 seconds to obtain an electrical conductive roller having a ultraviolet cured resin coating layer [thickness: 20 μm] on its surface. The thus obtained electrical conductive roller is evaluated by a test for the durability of the roller of the following method. Also, the elongation at break of the ultraviolet cured resin formed by curing the paint for the resin coating layer through irradiation of ultraviolet rays is measured by the following method. The results are shown in Tables 1-3.

(1) Test for Durability of Roller

The electrical conductive roller is mounted onto the imaging apparatus as a developing roller and then the degree of chipping in the electrical conductive roller after the printing of 5000 papers is visually judged according to the following standard. A case that line is not observed on the surface of the roller or if observed, stepwise difference can not be confirmed is shown by “◯” and a case that the stepwise difference can be clearly confirmed on the surface of the roller is shown by “X”.

(2) Elongation at Break of Ultraviolet Cured Resin

It is evaluated by a tensile test method of plastic film and sheet according to JIS method (JIS K7127-1989). Concretely, a resin plate is prepared by curing a resin paint in a glass mold through irradiation of ultraviolet rays and cut into a strip of 20 cm in a length and 1-2.5 cm in width to obtain a sample. This sample is mounted on a tensile testing machine (STA-1150, made by Orientec Co., Ltd.) at a chuck distance of 10 cm to record an elongation at break.

TABLE 1

| | | | | Example | Example | Example | Comparative | Comparative |
|---|---|---|---|---|---|---|---|---|
| | | | | 1 | 2 | 3 | Example 1 | Example 2 |
| Paint for | oligomer | μF-8001 *1 | part | 60 | 60 | 80 | 60 | 90 |
| resin | | 3002A *2 | by | — | — | — | — | — |
| coating | monomer | AMO *3 | mass | 15 | — | — | — | — |
| layer | | DE *4 | | 10 | 5 | — | — | — |
| | | IB-XA *5 | | 15 | 35 | — | — | — |
| | | PO-A *6 | | — | — | 20 | — | — |
| | | BEPG-A *7 | | — | — | — | — | 10 |
| | | 1,6-HX-A *8 | | — | — | — | 40 | — |
| | initiator | IRGACURE184D *9 | | 1 | 1 | 1 | 1 | 1 |

| Elongation at break of ultraviolet cured resin (%) | | 198 | 200 | 85 | 10 | 60 |
|---|---|---|---|---|---|---|
| glass transition point (Tg) (° C.) | | 62 | 55 | 35 | 75 | 45 |
| friction coefficient | | 0.35 | 0.36 | 0.35 | 0.35 | 0.38 |
| elastic modulus (MPa) | | 180 | 160 | 160 | 1200 | 400 |
| Roller durable test | chipping of roller | ◯ | ◯ | ◯ | X | X |

TABLE 2

| | | | | Exam- | Exam- | Exam- | Exam- | Exam- | Exam- | Exam- | Compara- |
|---|---|---|---|---|---|---|---|---|---|---|---|
| | | | | ple | ple | ple | ple | ple | ple | ple | tive |
| | | | | 4 | 5 | 6 | 7 | 8 | 9 | 10 | Example 3 |
| Paint for | oligomer | UV-3000B *10 | part | 50 | 40 | 60 | 60 | 60 | — | — | 60 |
| resin | | UX-3301 *11 | by | — | — | — | — | — | 60 | 80 | — |
| coating | monomer | AMO *3 | mass | 50 | 60 | 40 | 40 | 20 | 40 | 20 | — |
| layer | | DE *4 | | — | — | 10 | — | — | — | — | — |
| | | IB-XA *5 | | — | — | — | — | 20 | — | — | — |
| | | PO-A *6 | | — | — | — | — | — | — | — | — |
| | | BEPG-A *7 | | — | — | 10 | — | — | — | — | — |
| | | 1,6-HX-A *8 | | — | — | — | — | — | — | — | 40 |
| | initiator | IRGACURE184D *9 | | 1 | 1 | 1 | 1 | 1 | 1 | 1 | 1 |

| Elongation at break of ultraviolet cured resin (%) | | 500 | 400 | 190 | 328 | 207 | 150 | 150 | 15 |
|---|---|---|---|---|---|---|---|---|---|
| glass transition point (Tg) (° C.) | | 35 | 38 | 35 | 30 | 43 | 50 | 25 | 35 |
| friction coefficient | | 0.55 | 0.50 | 0.58 | 0.56 | 0.48 | 0.40 | 0.55 | 0.43 |
| elastic modulus (MPa) | | 250 | 230 | 180 | 200 | 180 | 200 | 180 | 250 |
| Roller durable test | chipping of roller | ◯ | ◯ | ◯ | ◯ | ◯ | ◯ | ◯ | X |

TABLE 3

| | | | | Example | Example | Example | Comparative | Comparative | Comparative | Example |
|---|---|---|---|---|---|---|---|---|---|---|
| | | | | 11 | 12 | 13 | Example 4 | Example 5 | Example 6 | 14 |
| Paint for | oligomer | UX-3204 *12 | part by | 50 | 60 | — | | 90 | — | — |
| resin | | UV-3200B *13 | mass | | | — | | | 100 | — |
| coating | | UV-3310B *14 | | — | — | 60 | 90 | — | — | 90 |
| layer | monomer | AMO *3 | | 50 | 40 | 30 | | — | — | 5 |
| | | DE *4 | | — | — | — | | — | — | — |
| | | IB-XA *5 | | — | — | 10 | | — | — | — |
| | | PO-A *6 | | — | — | — | | — | — | — |
| | | BEPG-A *7 | | — | — | — | | — | — | — |
| | | 1,6-HX-A *8 | | — | — | — | 10 | 10 | — | 10 |
| | initiator | IRGACURE184D *9 | | 1 | 1 | 1 | 1 | 1 | 1 | 1 |

| Elongation at break of ultraviolet cured resin (%) | | 450 | 264 | 239 | 60 | 32 | 60 | 80 |
|---|---|---|---|---|---|---|---|---|
| glass transition point (Tg) (° C.) | | 35 | 30 | 70 | 70 | 15 | 5 | 55 |
| friction coefficient | | 0.48 | 0.58 | 0.35 | 0.28 | 0.68 | 0.65 | 0.35 |
| elastic modulus (MPa) | | 250 | 190 | 250 | 350 | 80 | 350 | 340 |
| Roller durable test | chipping of roller | ◯ | ◯ | ◯ | X | X | X | Δ |

*1 urethane acrylate oligomer, made by Kyoeisha Chemical Co., Ltd. weight average molecular weight: 4500
*2 epoxy acrylate oligomer, made by Kyoeisha Chemical Co., Ltd. weight average molecular weight: 600
*3 polar group-containing acrylate monomer, acryloylmorpholine, made by Shin-Nakamura Kagaku Kogyo Co., Ltd.
*4 polar group-containing methacrylate monomer, N,N-diethylaminoethyl methacrylate, made by Kyoeisha Chemical Co., Ltd.
*5 bulky substituent-containing acrylate monomer, isobornyl acrylate, made by Kyoeisha Chemical Co., Ltd.
*6 bulky substituent-containing acrylate monomer, phenoxyethyl acrylate, made by Kyoeisha Chemical Co., Ltd.
*7 2-butyl-2-ethyl-1,3-propanediol diacrylate, made by Kyoeisha Chemical Co., Ltd.
*8 1,6-hexanediol diacrylate, made by Kyoeisha Chemical Co., Ltd.
*9 1-hydroxycyclohexylphenyl ketone, made by Ciba Specialty Chemicals Co., Ltd.
*10 urethane acrylate oligomer, made by Nippon Synthetic Chemical Industry Co., Ltd. weight average molecular weight: 18000
*11 urethane acrylate oligomer, made by Nihon Kayaku Co., Ltd. weight average molecular weight: 8100
*12 urethane acrylate oligomer, made by Nihon Kayaku Co., Ltd. weight average molecular weight: 11500
*13 urethane acrylate oligomer, made by Nippon Synthetic Chemical Industry Co., Ltd. weight average molecular weight: 10000
*14 urethane acrylate oligomer, made by Nippon Synthetic Chemical Industry Co., Ltd. weight average molecular weight: 5000

As seen from Tables 1-3, the electrical conductive rollers of the examples are superior in the durability to the electrical conductive rollers of the comparative examples because a ultraviolet cured resin having an elongation at break of not less than 80% obtained by curing a paint for resin coating layer comprising a (metha)acrylate monomer (B) having one functional group number and a bulky substituent or a polar group through irradiation of ultraviolet rays is used as a resin coating layer. Also, as seen from the results of Examples 1, 2, 8, 13 and 14, the electrical conductive roller according to the invention is excellent in the durability of the roller even if a (metha)acrylate monomer having a bulky substituent is combined with a (metha)acrylate monomer having a polar group. Furthermore, as seen from the results of Examples 6 and 13, the electrical conductive roller according to the invention may contain a (metha)acrylate monomer in addition to the above (metha)acrylate monomer (B).

Further, a roller body having an elastic layer with a specification common to Examples 15-33 and Comparative Examples 7-14 is prepared according to the following formulation.

(Preparation of Roller Body)

A polyurethane starting material is prepared by mixing 100 parts by mass of a polyol-modified tolylene diisocyanate having a NCO content of 6.7% by prepolymerization of a polyether polyol as an isocyanate component, 2.0 parts by mass of a conductive carbon black, 21 parts by mass of polyether polyol having a hydroxy value of 37.0 mgKOH/g and an average functional group number of 3, 19 parts by mass of polyether polyol having a hydroxy value of 388 mgKOH/g and an average functional group number of 3, 5 parts by mass of a reactive silicone foam stabilizer (polydimethyl siloxane/polyethylene oxide copolymer) having a hydroxy value of 34 mgKOH/g, 0.3 part by mass of sodium perchlorate and 0.2 part by mass of dibutyltin dilaurate. The polyurethane starting material is expanded by a mechanical froth method. The expanded polyurethane starting material is poured in a mold set with a metal shaft to prepare a roller body having an elastic layer of a urethane foam about the periphery of the shaft. Moreover, the expansion ratio of the thus obtained urethane foam is 1.6 times.

### EXAMPLES 15-33 AND COMPARATIVE EXAMPLES 7-14

A paint for a resin coating layer having a compounding recipe as shown in Tables 4-8 is applied onto the surface of the roller body through a roll coater and then ultraviolet rays are irradiated at a ultraviolet irradiating intensity of 1500 mW/cm² for 5 seconds to obtain an electrical conductive roller having a ultraviolet cured resin coating layer [thickness: 20 μm] on its surface. The thus obtained electrical conductive roller is evaluated by tests for the printing durability and the durability of the roller of the following methods. Also, the glass transition point (Tg), friction coefficient and elongation at break of the resin coating layer are measured by the following methods. The results are shown in Tables 4-8.

(1) Test for Printing Durability

The electrical conductive roller is mounted onto an imaging apparatus as a developing roller, and then a flying amount of toners onto a photosensitive drum in a white portion after the printing is evaluated from a comparison of photographic densities by tape transferring. Moreover, a relative density to the white portion of 0.00 is measured every 1000 papers by using a Macbeth densitometer, and the number of printed papers at a time of exceeding the measured value over 0.20 is rendered into a durable limit number. When the durable limit number is not less than 8000 papers, the printing durability is good. Moreover, the test for the printing durability is stopped on the way in the electrical conductive roller of Example 25 due to the serious surface chipping of the roller and in the electrical conductive rollers of Examples 27, 28 and 30 due to the serious surface peeling of the roller, and the printed number at the stopping is shown in the tables.

(2) Test for the Durability of Roller

The electrical conductive roller is mounted onto the imaging apparatus as a developing roller and then the degree of chipping in the electrical conductive roller after the printing of 5000 papers is visually judged according to the following standard.

A case that line is not observed on the surface of the roller or if observed, stepwise difference can not be confirmed is shown by “◯” and a case that the stepwise difference can be clearly confirmed on the surface of the roller is shown by “X”.

Moreover, as an overall judgment for the durability, a case that the durable limit number in the test for the printing durability is not less than 8000 papers and the surface chipping of the roller in the test for the durability of roller can not be confirmed is shown by “◯”, and a case that the durable limit number in the test for the printing durability is less than 8000 papers or the surface chipping of the roller in the test for the durability of roller can be confirmed is shown by “X”.

(3) Glass Transition Point (Tg)

It is calculated from a film of 0.5 mm in thickness made by using the paint for the resin coating layer by means of a temperature variable viscoelasticity measuring meter.

(4) Friction Coefficient

A three-point average of static friction coefficient of the horizontally set electrical conductive roller is measured by a friction meter attached with a felt used for toner sealing. As the friction meter is used HEIDON TRYBOGEARMUSE TYPE: 941 made by Shinto Kagaku Co., Ltd.

(5) Elongation at Break and Elastic Modulus

It is evaluated by a tensile test method of plastic film and sheet according to JIS method (JIS K7127-1989). Concretely, a resin plate is prepared by curing a resin paint in a glass mold through irradiation of ultraviolet rays and cut into a strip of 20 cm in a length and 1-2.5 cm in width to obtain a sample. This sample is mounted on a tensile testing machine (STA-1150, made by Orientec Co., Ltd.) at a chuck distance of 10 cm to record an elongation at break. Also, the elastic modulus is determined from a size and a stress obtained by measuring a stress when the sample is elongated to 5%.

TABLE 4

| | | | | Example | | | | | |
|---|---|---|---|---|---|---|---|---|---|
| | | | | 16 | 17 | 18 | 19 | 20 | 21 |
| Resin | Compounding | oligomer | UV3200B *1 | 60 | 60 | 60 | 60 | 60 | 60 |
| coating | recipe of paint | | UV3000B *2 | — | — | — | — | — | — |
| layer | | | UV3310B *3 | — | — | — | — | — | — |
| | | | UX3301 *4 | — | — | — | — | — | — |
| | | | UX3204 *5 | — | — | — | — | — | — |
| | | | UF8001 *6 | — | — | — | — | — | — |
| | | | 3002A *7 | — | — | — | — | — | — |
| | | monomer | AMO *8 | 20 | 20 | 20 | 20 | 20 | 20 |
| | | | IBXA *9 | 20 | 20 | 20 | 20 | 20 | 20 |
| | | | PO-A *10 | — | — | — | — | — | — |
| | | | DE *11 | — | — | — | — | — | — |
| | | | BEPG-A *12 | 5 | 5 | 5 | 5 | 5 | 5 |
| | | | 1,6HX-A *13 | — | — | — | — | — | — |
| | | fine particles | CFB101-40 *14 | 10 | — | — | 10 | 10 | — |
| | | | SS20 *15 | — | — | 15 | — | — | — |
| | | | C800 *16 | — | 10 | — | — | — | 10 |
| | | | MX500 *17 | 20 | — | — | — | 20 | — |
| | | silicon-containing | X22-2458*18 | — | — | — | 5 | 5 | 5 |
| | | resin and compound | X22-1602 *19 | — | — | — | — | — | — |
| | | fluorine-containing | V-3F *20 | — | — | — | — | — | — |
| | | resin and compound | FA-108 *21 | — | — | — | — | — | — |
| | | | Modiper F200 | — | — | — | — | — | — |
| | | | *22 | | | | | | |
| | | photopolymerization | IRGACURE184 | 1 | 1 | 1 | 1 | 1 | 1 |
| | | initiator | *23 | | | | | | |

| | | | | | | | |
|---|---|---|---|---|---|---|---|
| Properties | glass transition point (Tg) (° C.) | 56 | 56 | 56 | 75 | 75 | 70 |
| | friction coefficient | 0.43 | 0.39 | 0.4 | 0.35 | 0.35 | 0.39 |
| | elongation at break (%) | 209 | 230 | 210 | 180 | 180 | 190 |
| | elastic modulus (MPa) | 210 | 210 | 210 | 160 | 160 | 160 |

| | | | | | | | | |
|---|---|---|---|---|---|---|---|---|
| Evaluation | Test for printing durability | durable limit | 8 | 10 | 10 | 8 | 8 | 8 |
| | | number | | | | | | |
| | | (papers) | | | | | | |
| | Test for durability of roller | surface | ◯ | ◯ | ◯ | ◯ | ◯ | ◯ |
| | | chipping | | | | | | |

| | | | | | | |
|---|---|---|---|---|---|---|
| Overall judgment | ◯ | ◯ | ◯ | ◯ | ◯ | ◯ |

TABLE 5

| | | | | Example | | | | | |
|---|---|---|---|---|---|---|---|---|---|
| | | | | 22 | 23 | 24 | 25 | 26 | 27 |
| Resin | Compounding | oligomer | UV3200B *1 | 60 | 60 | 60 | — | — | — |
| coating | recipe of paint | | UV3000B *2 | — | — | — | — | — | — |
| layer | | | UV3310B *3 | — | — | — | 60 | 60 | — |
| | | | UX3301 *4 | — | — | — | — | — | — |
| | | | UX3204 *5 | — | — | — | — | — | — |
| | | | UF8001 *6 | — | — | — | — | — | 60 |
| | | | 3002A *7 | — | — | — | — | — | — |
| | | monomer | AMO *8 | 20 | 20 | 20 | 20 | 20 | — |
| | | | IBXA *9 | 20 | 20 | 20 | — | — | — |
| | | | PO-A *10 | — | — | — | 10 | 10 | — |
| | | | DE *11 | — | — | — | 10 | 10 | — |
| | | | BEPG-A *12 | 5 | 5 | 5 | 5 | 5 | — |
| | | | 1,6HX-A *13 | — | — | — | — | — | 40 |
| | | fine particles | CFB101-40 *14 | — | 10 | — | — | — | — |
| | | | SS20 *15 | 15 | — | — | — | — | — |
| | | | C800 *16 | — | — | — | — | — | — |
| | | | MX500 *17 | — | 20 | 20 | — | — | — |
| | | silicon-containing | X22-2458 *18 | 5 | 5 | — | — | 5 | — |
| | | resin and compound | X22-1602 *19 | — | — | — | — | — | — |
| | | fluorine-containing | V-3F *20 | — | — | — | — | — | — |
| | | resin and compound | FA-108 *21 | — | — | — | — | — | — |
| | | | Modiper F200 | — | — | — | — | — | — |
| | | | *22 | | | | | | |
| | | photopolymerization | IRGACURE184 | 1 | 1 | 1 | 1 | 1 | 1 |
| | | initiator | *23 | | | | | | |

| | | | | | | | |
|---|---|---|---|---|---|---|---|
| Properties | glass transition point (Tg) (° C.) | 70 | 60 | 56 | 70 | 70 | 68 |
| | friction coefficient | 0.43 | 0.35 | 0.46 | 0.32 | 0.28 | 0.38 |
| | elongation at break (%) | 190 | 180 | 210 | 290 | 120 | 10 |
| | elastic modulus (MPa) | 160 | 160 | 210 | 250 | 210 | 1200 |

| | | | | | | | | |
|---|---|---|---|---|---|---|---|---|
| Evaluation | Test for printing durability | durable limit | 10 | 8 | 8 | 6 | 8 | 10 |
| | | number | | | | | | |
| | | (papers) | | | | | | |
| | Test for durability of roller | surface | ◯ | ◯ | ◯ | ◯ | ◯ | X |
| | | chipping | | | | | | |

| | | | | | | |
|---|---|---|---|---|---|---|
| Overall judgment | ◯ | ◯ | ◯ | ◯ | X | X |

TABLE 6

| | | | | Example | | | | |
|---|---|---|---|---|---|---|---|---|
| | | | | 28 | 29 | 30 | 31 | 32 |
| Resin coating | Compounding | oligomer | UV3200B *1 | — | — | — | — | — |
| layer | recipe of paint | | UV3000B *2 | — | — | — | — | — |
| | | | UV3310B *3 | — | — | — | — | — |
| | | | UX3301 *4 | — | — | — | — | — |
| | | | UX3204 *5 | — | — | — | — | — |
| | | | UF8001 *6 | 60 | 60 | 60 | 60 | 60 |
| | | | 3002A *7 | — | — | — | — | 20 |
| | | monomer | AMO *8 | — | — | 15 | 15 | — |
| | | | IBXA *9 | — | — | 15 | 15 | — |
| | | | PO-A *10 | — | — | — | — | 10 |
| | | | DE *11 | — | — | 10 | 10 | — |
| | | | BEPG-A *12 | — | — | — | — | — |
| | | | 1,6HX-A *13 | 40 | 40 | — | — | — |
| | | fine particles | CFB101-40 *14 | — | — | 10 | 10 | 10 |
| | | | SS20 *15 | — | — | — | — | — |
| | | | C800 *16 | — | — | — | — | — |
| | | | MX500 *17 | — | — | — | — | — |
| | | silicon-containing resin and | X22-2458 *18 | 5 | — | — | 5 | — |
| | | compound | X22-1602 *19 | — | — | — | — | — |
| | | fluorine-containing resin | V-3F *20 | — | — | — | — | — |
| | | and compound | FA-108 *21 | — | 5 | — | — | — |
| | | | Modiper F200 *22 | — | — | — | — | — |
| | | photopolymerization | IRGACURE 184 *23 | 1 | 1 | 1 | 1 | 1 |
| | | initiator | | | | | | |

| | | | | | | |
|---|---|---|---|---|---|---|
| Properties | glass transition point (Tg) (° C.) | 68 | 68 | 62 | 70 | 50 |
| | friction coefficient | 0.38 | 0.38 | 0.35 | 0.28 | 0.34 |
| | elongation at break (%) | 10 | 10 | 200 | 110 | 120 |
| | elastic modulus (MPa) | 1200 | 1200 | 180 | 170 | 300 |

| | | | | | | | |
|---|---|---|---|---|---|---|---|
| Evaluation | Test for printing durability | durable limit number | 6 | 6 | 8 | 10 | 10 |
| | | (papers) | | | | | |
| | Test for durability of roller | surface chipping | X | X | ◯ | ◯ | Δ |

| | | | | | |
|---|---|---|---|---|---|
| Overall judgment | X | X | ◯ | X | X |

TABLE 7

| | | | | | | Comparative | | |
|---|---|---|---|---|---|---|---|---|
| | | | | Example | | Example | | |
| | | | | 33 | 34 | 7 | 8 | 9 |
| Resin coating | Compounding | oligomer | UV3200B *1 | — | — | 60 | 60 | 60 |
| layer | recipe of paint | | UV3000B *2 | — | — | — | — | — |
| | | | UV3310B *3 | — | — | — | — | — |
| | | | UX3301 *4 | 60 | — | — | — | — |
| | | | UX3204 *5 | — | — | — | — | — |
| | | | UF8001 *6 | — | 60 | — | — | — |
| | | | 3002A *7 | — | — | — | — | — |
| | | monomer | AMO *8 | 40 | — | 20 | 20 | 20 |
| | | | IBXA *9 | — | — | 20 | 20 | 20 |
| | | | PO-A *10 | — | — | — | — | — |
| | | | DE *11 | — | — | — | — | — |
| | | | BEPG-A *12 | — | 40 | 5 | 5 | 5 |
| | | | 1,6HX-A *13 | — | — | — | — | — |
| | | fine particles | CFB101-40 *14 | — | — | 10 | 10 | 10 |
| | | | SS20 *15 | — | — | — | — | — |
| | | | C800 *16 | — | — | — | — | — |
| | | | MX500 *17 | — | — | — | — | — |
| | | silicon-containing resin and | X22-2458 *18 | — | — | — | — | — |
| | | compound | X22-1602 *19 | — | — | — | 5 | — |
| | | fluorine-containing resin and | V-3F *20 | — | — | — | — | 5 |
| | | compound | FA-108 *21 | — | — | — | — | — |
| | | | Modiper F200 *22 | — | — | — | — | — |
| | | photopolymerization | IRGACURE 184 *23 | 1 | 1 | 1 | 1 | 1 |
| | | initiator | | | | | | |

| | | | | | | |
|---|---|---|---|---|---|---|
| Properties | glass transition point (Tg) (° C.) | 50 | 70 | 56 | 70 | 40 |
| | friction coefficient | 0.40 | 0.37 | 0.62 | 0.55 | 0.58 |
| | elongation at break (%) | 220 | 40 | 210 | 180 | 220 |
| | elastic modulus (MPa) | 200 | 1200 | 210 | 160 | 160 |

| | | | | | | | |
|---|---|---|---|---|---|---|---|
| Evaluation | Test for printing durability | durable limit number | 7 | 10 | 6 | 8 | 8 |
| | | (papers) | | | | | |
| | Test for durability of roller | surface chipping | ◯ | X | ◯ | ◯ | ◯ |

| | | | | | |
|---|---|---|---|---|---|
| Overall judgment | ◯ | ◯ | X | X | X |

TABLE 8

| | | | | Comparative Example | | | | |
|---|---|---|---|---|---|---|---|---|
| | | | | 10 | 11 | 12 | 13 | 14 |
| Resin coating | Compounding | oligomer | UV3200B *1 | 60 | 60 | — | — | — |
| layer | recipe of paint | | UV3000B *2 | — | — | 60 | 60 | — |
| | | | UV3310B *3 | — | — | — | — | — |
| | | | UX3301 *4 | — | — | — | — | — |
| | | | UX3204 *5 | — | — | — | — | 60 |
| | | | UF8001 *6 | — | — | — | — | — |
| | | | 3002A *7 | — | — | — | — | — |
| | | monomer | AMO *8 | 20 | 20 | 40 | 40 | 40 |
| | | | IBXA *9 | 20 | 20 | — | — | — |
| | | | P0-A *10 | — | — | — | — | — |
| | | | DE *11 | — | — | — | — | — |
| | | | BEPG-A *12 | 5 | 5 | — | — | — |
| | | | 1,6HX-A *13 | — | — | — | — | — |
| | | fine particles | CFB101-40 *14 | 10 | 10 | 10 | 10 | — |
| | | | SS20 *15 | — | — | — | — | — |
| | | | C800 *16 | — | — | — | — | — |
| | | | MX500 *17 | — | — | — | — | — |
| | | silicon-containing resin and | X22-2458 *18 | — | — | — | 5 | — |
| | | compound | X22-1602 *19 | — | — | — | — | — |
| | | fluorine-containing resin and | V-3F *20 | — | — | — | — | — |
| | | compound | FA-108 *21 | 5 | — | — | — | — |
| | | | Modiper F200 *22 | — | 5 | — | — | — |
| | | photopolymerization | IRGACURE184 *23 | 1 | 1 | 1 | 1 | 1 |
| | | initiator | | | | | | |

| | | | | | | |
|---|---|---|---|---|---|---|
| Properties | glass transition point (Tg) (° C.) | 60 | 50 | 30 | 45 | 30 |
| | friction coefficient | 0.58 | 0.63 | 0.56 | 0.53 | 0.58 |
| | elongation at break (%) | 190 | 210 | 500 | 300 | 450 |
| | elastic modulus (MPa) | 160 | 160 | 180 | 160 | 180 |

| | | | | | | | |
|---|---|---|---|---|---|---|---|
| Evaluation | Test for printing durability | durable limit number | 6 | 6 | 6 | 6 | 6 |
| | | (papers) | | | | | |
| | Test for durability of roller | surface chipping | ◯ | ◯ | ◯ | ◯ | ◯ |

| | | | | | |
|---|---|---|---|---|---|
| Overall judgment | X | X | X | X | X |

*1 urethane acrylate oligomer, made by Nippon Synthetic Chemical Industry Co., Ltd. weight average molecular weight: 10000
*2 urethane acrylate oligomer, made by Nippon Synthetic Chemical Industry Co., Ltd. weight average molecular weight: 18000
*3 urethane acrylate oligomer, made by Nippon Synthetic Chemical Industry Co., Ltd. weight average molecular weight: 5000
*4 urethane acrylate oligomer, made by Nihon Kayaku Co., Ltd. weight average molecular weight: 8100
*5 urethane acrylate oligomer, made by Nihon Kayaku Co., Ltd. weight average molecular weight: 11500
*6 urethane acrylate oligomer, made by Kyoeisha Chemical Co., Ltd. weight average molecular weight: 4500
*7 epoxy acrylate oligomer, made by Kyoeisha Chemical Co., Ltd. weight average molecular weight: 600
*8 polar group-containing acrylate monomer, acryloylmorpholine, made by Shin-Nakamura Kagaku Kogyo Co., Ltd.
*9 bulky substituent-containing acrylate monomer, isobornyl acrylate, made by Kyoeisha Chemical Co., Ltd.
*10 bulky substituent-containing acrylate monomer, phenoxyethyl acrylate, made by Kyoeisha Chemical Co., Ltd.
*11 polar group-containing methacrylate monomer, N,N-diethylaminoethyl methacrylate, made by Kyoeisha Chemical Co., Ltd.
*12 2-butyl-2-ethyl-1,3-propanediol diacrylate, made by Kyoeisha Chemical Co., Ltd.
*13 1,6-hexanediol diacrylate, made by Kyoeisha Chemical Co., Ltd.
*14 urethane fine particles, made by Dainippon Ink and Chemicals, Inc.
*15 silica gel, made by Nippon Silica Kogyo Co., Ltd.
*16 urethane fine particles, made by Negami Kogyo Co., Ltd.
*17 acryl fine particles, made by Soken Kagaku Co., Ltd.
*18 silicon acrylate, made by Shin-Etsu Silicon Co., Ltd.
*19 silicon acrylate, made by Shin-Etsu Silicon Co., Ltd.
*20 trifluoroethyl acrylate, made by Osaka Organic Chemical Industry Ltd.
*21 perfluorooctylethyl acrylate, made by Kyoeisha Chemical Co., Ltd.
*22 fluorinated block copolymer, made by NOF Corporation
*23 1-hydroxycyclohexylphenyl ketone, made by Ciba Specialty Chemicals Co., Ltd.

As seen from Tables 4-8, the electrical conductive rollers of the examples have a glass transition point (Tg) of not lower than 40° C. and a friction coefficient of not more than 0.5, so that the imaging apparatus using such an electrical conductive roller as a developing roller can form good images over a long time or period.

1. An electrical conductive roller comprising a shaft member, an elastic layer disposed on an outer side of the shaft member in a radial direction and at least one resin coating layer disposed on an outer side of the elastic layer in the radial direction, wherein a resin coating layer at least adjacent to the elastic layer is made of a ultraviolet-cured resin formed by curing a paint for the resin coating layer comprising (A) a (metha)acrylate oligomer, (B) a (metha)acrylate monomer and (C) a photopolymerization initiator through irradiation of ultraviolet rays, and having an elongation at break of not less than 80%.

2. An electrical conductive roller according to claim 1, wherein the resin coating layer has a glass transition point (Tg) of not lower than 40° C. and a friction coefficient of not more than 0.5.

3. An electrical conductive roller according to claim 1, wherein the (metha)acrylate oligomer (A) has a weight average molecular weight of not less than 4500.

4. An electrical conductive roller according to claim 1, wherein the (metha)acrylate oligomer (A) is a urethane-based (metha)acrylate oligomer.

5. An electrical conductive roller according to claim 1, wherein the (metha)acrylate monomer (B) is at least one selected from acryloylmorpholine, N,N-diethylaminoethyl methacrylate, isobornyl acrylate and phenoxyethyl acrylate.

6. An electrical conductive roller according to claim 1, wherein a content of the (metha)acrylate monomer (B) in a sum of the (metha)acrylate oligomer (A) and the (metha)acrylate monomer (B) is 5-60% by mass.

7. An electrical conductive roller according to claim 1, wherein the resin coating layer contains finer particles.

8. An electrical conductive roller according to claim 1, wherein the resin coating layer contains at least one selected from fluorine-containing resin and compound and silicon-containing resin and compound.

9. An imaging apparatus comprising an electrical conductive roller as claimed claim 1.
